(19) United States
(12) Patent Application Publication
(10) Pub. No.: US 2024/0330048 A1
(43) Pub. Date: Oct. 3, 2024

(54) APPARATUS AND METHOD FOR DYNAMIC CORE MANAGEMENT

(71) Applicant: Intel Corporation, Santa Clara, CA (US)

(72) Inventors: Efraim ROTEM, Santa Clara, CA (US); Stephen H. GUNTHER, Beaverton, OR (US); Rajshree CHABUKSWAR, Sunnyvale, CA (US); Vishwesh MAGODE RUDRAMUNI, Bangalore (IN); Bharath Kumar VEERA, Portland, OR (US); Joseph ALBERTS, Aloha, OR (US); Madhusudan CHIDAMBARAM, Bangalore (IN); Zhongsheng WANG, Camas, WA (US); Preeti AGARWAL, Portland, OR (US); Praveen Kumar GUPTA, Santa Clara, CA (US)

(21) Appl. No.: 18/128,977

(22) Filed: Mar. 30, 2023

(51) Int. Cl. G06F 9/48

(52) U.S. Cl. CPC G06F 9/4893

(57) ABSTRACT

An apparatus and method are described for intelligently scheduling threads across a plurality of logical processors. For example, one embodiment of a processor comprises: a plurality of cores and power management circuitry to associate a plurality of performance values and a plurality of efficiency values with the plurality of cores. In some implementations, each core is associated with at least one performance value and at least one efficiency value. The performance values and efficiency values are used by a scheduler for scheduling threads on the plurality of cores. Some implementations include dynamic core configuration hardware logic coupled to or integral to the power management circuitry to resolve a plurality of configuration requests into a consolidated request for updating one or more performance values of the plurality of performance values and/or one or more efficiency values of the plurality of efficiency values.

### BACKGROUND

### Field of the Invention

The embodiments of the invention relate generally to the field of computer processors. More particularly, the embodiments relate to an apparatus and method for dynamic core management such as when performing core parking and/or consolidation.

### Description of the Related Art

With hybrid processor architectures, scheduling is a critical for compute performance. Existing scheduling techniques deliver good performance on highly threaded, high load applications. In client platforms, however, various types of workloads (e.g., such as gaming and productivity) under-utilize the cores or pass through phases of fully utilized to under utilized, when better PnP can be achieved by reducing to an optimal number of cores.

The “optimal” number of cores can be difficult to determine. Algorithms today are split between two independent controls: operating system scheduling and Hardware P-state (HWP) control. The scheduling is done primarily by the OS in view of certain aspects of the application rather than based on the utilization of the threads/cores. However, HWP control adjusts the frequency of the cores based on utilization. As a result, scheduling on fewer cores will drive frequency up and vice versa. The OS is aware of the total compute capacity demand, priority and class of service of applications.

### BRIEF DESCRIPTION OF THE DRAWINGS

A better understanding of the present invention can be obtained from the following detailed description in conjunction with the following drawings, in which:

FIG. 1 is a block diagram of a portion of a system in accordance with an embodiment of the present invention.

FIG. 2 illustrates one embodiment comprising a hardware guide unit;

FIG. 3 illustrate details for one embodiment of a guide unit;

FIG. 4 illustrates thread agnostic rankings in accordance with one embodiment;

FIG. 5 illustrates thread specific rankings in accordance with one embodiment;

FIG. 6 illustrates one embodiment of a prediction circuit/logic using event vectors and prediction weights;

FIG. 7A illustrates event vectors in accordance with some embodiments;

FIG. 7B illustrates prediction weights in accordance with some embodiments;

FIG. 8 illustrates an architecture in accordance with some embodiments in which a global table is used to schedule execution on cores and/or logical processors;

FIG. 9 illustrates a method in accordance with one embodiment of the invention;

FIG. 10 illustrates a disaggregated tile-based architecture on which embodiments of the invention may be implemented;

FIG. 11 illustrates additional details of one embodiment of the disaggregated tile-based architecture;

FIG. 12 illustrates communication between power units in accordance with one embodiment;

FIG. 13 illustrates a plurality of power management stages for rendering power management decisions in accordance with one embodiment;

FIG. 14 illustrates one embodiment for generating a unified hint/request based on a plurality of generated hints;

FIGS. 15A-D illustrates a method in accordance with one embodiment of the invention;

FIG. 16 illustrates an example of class coding and an associated power management process;

FIG. 17 illustrates an embodiment for determining a number of active cores based, at least in part, on utilization thresholds;

FIG. 18 illustrates power management values generated by per-IP block power maintenance operations;

FIG. 19 illustrates one embodiment which uses energy performance preference (EPP) values for cores and accelerators;

FIG. 20 illustrates an embodiment for determining operating frequency of different IP blocks;

FIG. 21 illustrates a method in accordance with one embodiment of the invention;

FIG. 22 illustrates an embodiment for determining operating frequency of different IP blocks based on temperature;

FIG. 23 illustrates one embodiment including a temperature-limit driven frequency controller;

FIG. 24 illustrates an example of relationships between core frequency and temperature over time; and

FIG. 25A-B illustrate task scheduling and migration in accordance with some embodiments.

### DETAILED DESCRIPTION

In various embodiments, techniques are provided for managing power and thermal consumption in a heterogeneous (hetero) processor. As used herein the term “hetero processor” refers to a processor including multiple different types of processing engines. For example, a hetero processor may include two or more types of cores that have different microarchitectures, instruction set architectures (ISAs), voltage/frequency (VF) curves, and/or more broadly power/performance characteristics.

Optimal design/operating point of a heterogeneous processor (in terms of VF characteristics, instructions per cycle (IPC), functionality/ISA, etc.) is dependent on both inherent/static system constraints (e.g., common voltage rail) and a dynamic execution state (e.g., type of workload demand, power/thermal state, etc.). To extract power efficiency and performance from such architectures, embodiments provide techniques to determine/estimate present hardware state/capabilities and to map application software requirements to hardware blocks. With varying power/thermal state of a system, the relative power/performance characteristics of different cores change. Embodiments take these differences into account to make both local and globally optimal decisions. As a result, embodiments provide dynamic feedback of per core power/performance characteristics.

More specifically, embodiments provide closed loop control of resource allocation (e.g., power budget) and operating point selection based on the present state of heterogeneous hardware blocks. In embodiments, a hardware guided scheduling (HGS) interface is provided to communicate dynamic processor capabilities to an operating system (OS) based on power/thermal constraints.

Embodiments may dynamically compute hardware (HW) feedback information, including dynamically estimating processor performance and energy efficiency capabilities. As one particular example, a lookup table (LUT) may be accessed based on underlying power and performance (PnP) characteristics of different core types and/or post-silicon tuning based on power/performance bias.

In addition, embodiments may determine an optimal operating point for the heterogeneous processor. Such optimal operating point may be determined based at least in part on a present execution scenario, including varying workload demands (performance, efficiency, responsiveness, throughput, IO response) of different applications, and shifting performance and energy efficiency capabilities of heterogeneous cores.

In embodiments, the dynamically computed processor performance and energy efficiency capabilities may be provided to an OS scheduler. The feedback information takes into account power and thermal constraints to ensure that current hardware state is provided. In this way, an OS scheduler can make scheduling decisions that improve overall system performance and efficiency. Note that this feedback is not dependent on workload energy performance preference (EPP) or other software input. Rather, it is based on physical constraints that reflect current hardware state.

In contrast, conventional power management mechanisms assume all cores to be of the same type, and thus estimate the maximum achievable frequency on each core to be same for a given power budget. This is not accurate, as different cores may have different power/performance capabilities individually and they may have different maximum frequency based on other platform constraints. And further, conventional power management algorithms assume the same utilization target for all cores when calculating performance state (P-state) and hence do not take into account the heterogeneity of an underlying architecture. Nor do existing techniques optimize the operating points with an objective of mapping a particular type of thread to a core type based on optimizing power or performance.

In general, a HGS interface provides dynamic processor capabilities to the OS based on power/thermal constraints. The OS takes this feedback as an input to a scheduling algorithm and maps workload demand to hetero compute units. The scheduler's mapping decisions may be guided by different metrics such as performance, efficiency or responsiveness, etc. The scheduling decisions in turn impact processor states, hence forming a closed loop dependence. Since workload demand, in terms of power/performance requirements, can vary by large margins, any change in scheduling decisions can cause a large shift in HGS feedback, leading to unacceptable stability issues. Embodiments provide techniques that are independent/resilient of the scheduling decisions or other software inputs from the operating system, and thus avoid these stability issues.

Although the following embodiments are described with reference to specific integrated circuits, such as in computing platforms or processors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to any particular type of computer systems. That is, disclosed embodiments can be used in many different system types, ranging from server computers (e.g., tower, rack, blade, micro-server and so forth), communications systems, storage systems, desktop computers of any configuration, laptop, notebook, and tablet computers (including 2:1 tablets, phablets and so forth), and may be also used in other devices, such as handheld devices, systems on chip (SoCs), and embedded applications. Some examples of handheld devices include cellular phones such as smartphones, Internet protocol devices, digital cameras, personal digital assistants (PDAs), and handheld PCs. Embedded applications may typically include a microcontroller, a digital signal processor (DSP), network computers (NetPC), set-top boxes, network hubs, wide area network (WAN) switches, wearable devices, or any other system that can perform the functions and operations taught below. More so, embodiments may be implemented in mobile terminals having standard voice functionality such as mobile phones, smartphones and phablets, and/or in non-mobile terminals without a standard wireless voice function communication capability, such as many wearables, tablets, notebooks, desktops, micro-servers, servers and so forth. Moreover, the apparatuses, methods, and systems described herein are not limited to physical computing devices, but may also relate to software optimizations.

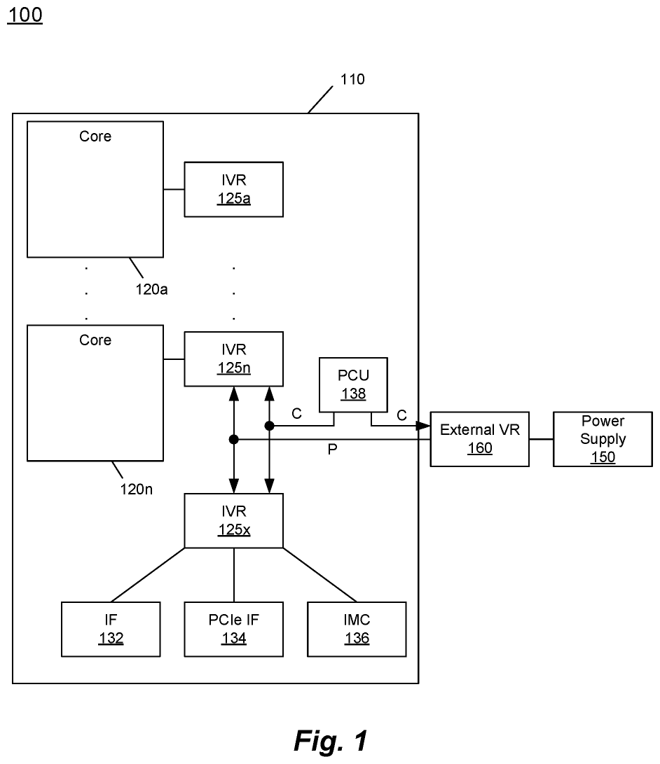

Referring now to FIG. 1, shown is a block diagram of a portion of a system in accordance with an embodiment of the present invention. As shown in FIG. 1, system 100 may include various components, including a processor 110 which as shown is a multicore processor. Processor 110 may be coupled to a power supply 150 via an external voltage regulator 160, which may perform a first voltage conversion to provide a primary regulated voltage to processor 110.

As seen, processor 110 may be a single die processor including multiple cores 120 a-120 n. In addition, each core may be associated with an integrated voltage regulator (IVR) 125 a-125 n which receives the primary regulated voltage and generates an operating voltage to be provided to one or more agents of the processor associated with the IVR. Accordingly, an IVR implementation may be provided to allow for fine-grained control of voltage and thus power and performance of each individual core. As such, each core can operate at an independent voltage and frequency, enabling great flexibility and affording wide opportunities for balancing power consumption with performance. In some embodiments, the use of multiple IVRs enables the grouping of components into separate power planes, such that power is regulated and supplied by the IVR to only those components in the group. During power management, a given power plane of one IVR may be powered down or off when the processor is placed into a certain low power state, while another power plane of another IVR remains active, or fully powered.

Still referring to FIG. 1, additional components may be present within the processor including an input/output interface 132, another interface 134, and an integrated memory controller 136. As seen, each of these components may be powered by another integrated voltage regulator 125 x. In one embodiment, interface 132 may be enable operation for an Intel® Quick Path Interconnect (QPI) interconnect, which provides for point-to-point (PtP) links in a cache coherent protocol that includes multiple layers including a physical layer, a link layer and a protocol layer. In turn, interface 134 may communicate via a Peripheral Component Interconnect Express (PCIe™) protocol.

Also shown is a power control unit (PCU) 138, which may include hardware, software and/or firmware to perform power management operations with regard to processor 110. As seen, PCU 138 provides control information to external voltage regulator 160 via a digital interface to cause the voltage regulator to generate the appropriate regulated voltage. PCU 138 also provides control information to IVRs 125 via another digital interface to control the operating voltage generated (or to cause a corresponding IVR to be disabled in a low power mode). In various embodiments, PCU 138 may include a variety of power management logic units to perform hardware-based power management. Such power management may be wholly processor controlled (e.g., by various processor hardware, and which may be triggered by workload and/or power, thermal or other processor constraints) and/or the power management may be performed responsive to external sources (such as a platform or management power management source or system software).

In embodiments herein, PCU 138 may be configured to dynamically determine hardware feedback information regarding performance and energy efficiency capabilities of hardware circuits such as cores 120 and provide an interface to enable communication of this information to an OS scheduler, for use in making better scheduling decisions. To this end, PCU 138 may be configured to determine and store such information, either internally to PCU 138 or in another storage of system 100.

Furthermore, while FIG. 1 shows an implementation in which PCU 138 is a separate processing engine (which may be implemented as a microcontroller), understand that in some cases in addition to or instead of a dedicated power controller, each core may include or be associated with a power control agent to more autonomously control power consumption independently. In some cases a hierarchical power management architecture may be provided, with PCU 138 in communication with corresponding power management agents associated with each of cores 120.

While not shown for ease of illustration, understand that additional components may be present within processor 110 such as uncore logic, and other components such as internal memories, e.g., one or more levels of a cache memory hierarchy and so forth. Furthermore, while shown in the implementation of FIG. 1 with an integrated voltage regulator, embodiments are not so limited.

Processors described herein may leverage power management techniques that may be independent of and complementary to an operating system (OS)-based power management (OSPM) mechanism. According to one example OSPM technique, a processor can operate at various performance states or levels, so-called P-states, namely from P0 to PN. In general, the P1 performance state may correspond to the highest guaranteed performance state that can be requested by an OS. In addition to this P1 state, the OS can further request a higher performance state, namely a P0 state. This P0 state may thus be an opportunistic or turbo mode state in which, when power and/or thermal budget is available, processor hardware can configure the processor or at least portions thereof to operate at a higher than guaranteed frequency. In many implementations a processor can include multiple so-called bin frequencies above the P1 guaranteed maximum frequency, exceeding to a maximum peak frequency of the particular processor, as fused or otherwise written into the processor during manufacture. In addition, according to one OSPM mechanism, a processor can operate at various power states or levels. With regard to power states, an OSPM mechanism may specify different power consumption states, generally referred to as C-states, C0, C1 to Cn states. When a core is active, it runs at a C0 state, and when the core is idle it may be placed in a core low power state, also called a core non-zero C-state (e.g., C1-C6 states), with each C-state being at a lower power consumption level (such that C6 is a deeper low power state than C1, and so forth).

Understand that many different types of power management techniques may be used individually or in combination in different embodiments. As representative examples, a power controller may control the processor to be power managed by some form of dynamic voltage frequency scaling (DVFS) in which an operating voltage and/or operating frequency of one or more cores or other processor logic may be dynamically controlled to reduce power consumption in certain situations. In an example, DVFS may be performed using Enhanced Intel SpeedStep™ technology available from Intel Corporation, Santa Clara, Calif., to provide optimal performance at a lowest power consumption level. In another example, DVFS may be performed using Intel TurboBoost™ technology to enable one or more cores or other compute engines to operate at a higher than guaranteed operating frequency based on conditions (e.g., workload and availability).

Another power management technique that may be used in certain examples is dynamic swapping of workloads between different compute engines. For example, the processor may include asymmetric cores or other processing engines that operate at different power consumption levels, such that in a power constrained situation, one or more workloads can be dynamically switched to execute on a lower power core or other compute engine. Another exemplary power management technique is hardware duty cycling (HDC), which may cause cores and/or other compute engines to be periodically enabled and disabled according to a duty cycle, such that one or more cores may be made inactive during an inactive period of the duty cycle and made active during an active period of the duty cycle.

### Thread Scheduling Based on Processor Information

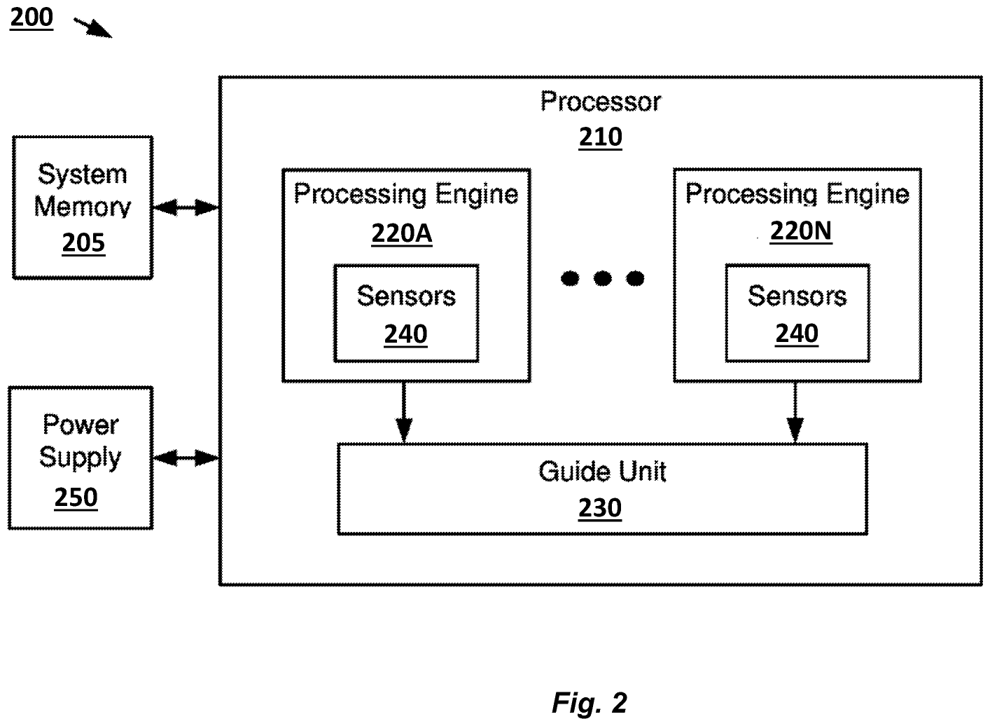

Referring now to FIG. 2, shown is a block diagram of a system 200 in accordance with one or more embodiments. In some embodiments, the system 200 may be all or a portion of an electronic device or component. For example, the system 200 may be a cellular telephone, a computer, a server, a network device, a system on a chip (SoC), a controller, a wireless transceiver, a power supply unit, etc. Furthermore, in some embodiments, the system 200 may be part of a grouping of related or interconnected devices, such as a datacenter, a computing cluster, etc.

As shown in FIG. 2, the system 200 may include a processor 210 operatively coupled to system memory 205 and a power supply 250. Further, although not shown in FIG. 2, the system 200 may include other components. In one or more embodiments, the system memory 205 can be implemented with any type(s) of computer memory (e.g., dynamic random-access memory (DRAM), static random-access memory (SRAM), non-volatile memory (NVM), a combination of DRAM and NVM, etc.). The power supply 250 may provide electrical power to the processor 210.

In one or more embodiments, the processor 210 may be a hardware processing device (e.g., a central processing unit (CPU), a System on a Chip (SoC), and so forth). As shown, the processor 210 can include any number of processing engines 220A-220N (also referred to generally as processing engines 220) and a guide unit 230. Each processing engine 220 can include one or more sensors 240 to provide measurements regarding the processing engine 220 to the guide unit 230. For example, the sensors 240 may provide measurements regarding processing engine performance, efficiency, power usage, temperature, reliability, thread execution, and so forth.

In one or more embodiments, the guide unit 230 may be a hardware component of the processor 210 to provide processing engine information to guide a thread scheduler (not shown). In some embodiments, the processing engine information may include one or more rankings of processing engines (e.g., thread agnostic rankings, thread specific rankings, and so forth). Further, in some embodiments, the processing engine information may include one or more predicted characteristics of a processing engine. Various aspects of the guide unit 230 are described below.

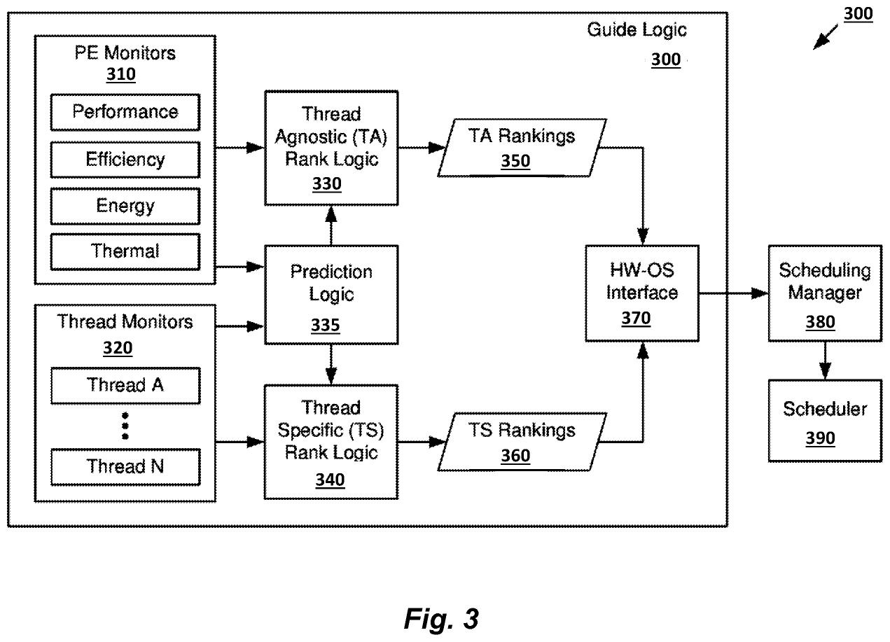

Referring to FIG. 3, shown is a diagram of an example system 305, in accordance with one or more embodiments. The system 305 may include guide logic 300, a scheduling manager 380, and a scheduler 390. The guide logic 300 may correspond generally to some or all of the guide unit 230 (shown in FIG. 2). In some embodiments, the guide logic 300 may be implemented at least in part using hardware.

As shown in FIG. 3, the guide logic 300 may include processing engine (PE) monitors 310, thread monitors 320, thread agnostic (TA) rank logic 330, prediction logic 335, thread specific (TS) rank logic 340, and a hardware-operating system (HW-OS) interface 370. As used herein, “thread agnostic rank” refers to a rank that is independent from any particular thread or workload type. For example, some workload types may include compute-intensive (e.g., PE resources required), memory-intensive (e.g., memory controller bandwidth required), highly-parallelized (e.g., graphics processing resources required), accelerated (e.g., accelerator resources required), and so forth. In some embodiments, a single thread may be characterized as one or more workload types depending the instructions included in an instruction sequence.

In one or more embodiments, the PE monitors 310 may monitor characteristics of each PE without regard to a specific workload or thread. The monitored characteristics of each PE may include performance, efficiency, energy use, thermal, and reliability characteristics. For example, the PE monitors 310 may monitor metrics such as instructions per clock cycle, power consumed per time period, percentage of maximum performance, average power state, temperature, percentage of lifecycle that has elapsed, total number of power cycles, maximum power level, and so forth. The PE monitors 310 may be implemented using hardware counters.

In some embodiments, the PE monitors 310 may monitor and/or count system events representing PE execution characteristics (e.g., microarchitecture events, architecture events, system events, etc.). For example, the PE monitors 310 may determine the number of floating point instruction retired, the number of memory instructions retired, the number of branch mispredictions, the number of cache misses, the number of pipeline stalls, and so forth.

In one or more embodiments, the thread monitors 320 may monitor characteristics of individual threads. For example, the thread monitors 320 may monitor metrics such as instructions completed per time period, idle time, and so forth. Further, the thread monitors 320 may determine an execution profile and/or type, such as graphics processing, network processing, floating point calculation, encryption processing, and so forth. The thread monitors 320 may be implemented using hardware counters.

In some embodiments, the prediction logic 335 may use data from the PE monitors 310 and/or the thread monitors 320 to predict the performance of a thread on multiple PEs. For example, assume that a first thread is currently executing on a first PE (e.g., PE 220A shown in FIG. 2) of a processor having multiple PEs. In some embodiments, the prediction logic 335 may analyze characteristics of the first thread, the first PE, and other PEs (e.g., PE 220N shown in FIG. 2) to predict characteristics of the first thread if it were to instead be executed on the other PEs (e.g., if the first thread were moved to a second PE). The predictions performed by the prediction logic 335 are described further below.

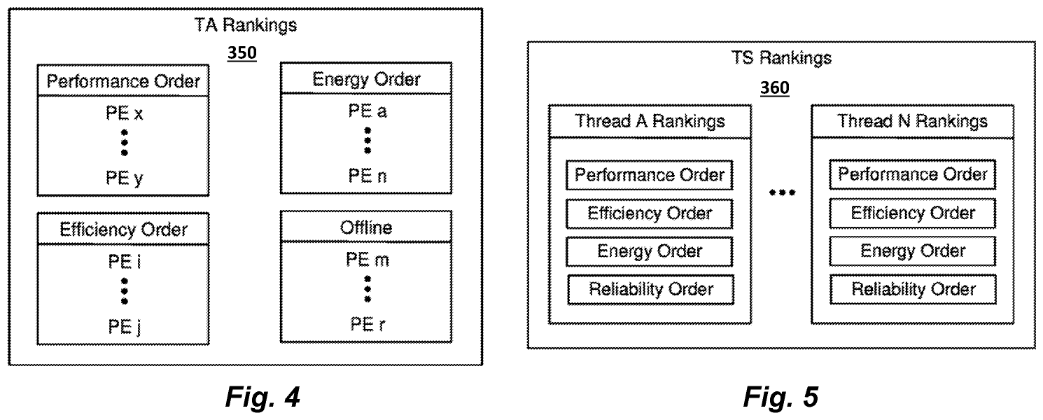

In one or more embodiments, the TA rank logic 330 may use data from the PE monitors 310 and/or the prediction logic 335 to generate one or more TA rankings 350. In some embodiments, each TA ranking 350 may include a list of PEs arranged in a particular thread agnostic order. Referring now to FIG. 4, shown is an example set of TA rankings 350, in accordance with some embodiments. Specifically, as shown in FIG. 4, the TA rankings 350 may include a performance order ranking, an efficiency order ranking, an energy order ranking, and an offline order ranking. In some embodiments, the performance order ranking may reflect the relative performance capabilities of the PEs (e.g., from fast processing to slowest processing). The efficiency order ranking may reflect the relative energy efficiency capabilities of the PEs (e.g., from most efficient to least efficient). The energy order ranking may reflect the relative power consumption of the PEs. The offline order ranking may indicate which PEs are to be taken offline, and/or a sequential order of the PEs in which they should be taken offline if necessary. In some embodiments, the TA rankings 350 may be stored in a global processor location or structure. For example, the TA rankings 350 may be stored in registers of a processor (e.g., processor 210 shown in FIG. 2), in external memory (e.g., system memory 205 shown in FIG. 2), and so forth.

Referring again to FIG. 3, the TS rank logic 340 may use data from the thread monitors 320 and/or the prediction logic 335 to generate one or more TS rankings 360. In some embodiments, each TS ranking 360 may be associated with a particular thread, and may include a list of PEs arranged in an order specific to that particular thread. Referring now to FIG. 5, shown is an example set of TS rankings 360, in accordance with some embodiments. For example, the TS rankings 360 may a PE ranking for thread A, a PE ranking for thread B, and so forth. In some embodiments, the TS rankings 360 may be stored in global processor memory structure. For example, the TA rankings 350 may be stored in registers of a processor, in external memory, in a thread context block maintained by the OS, and so forth. In some embodiments, the TS rankings 360 may be generated and/or updated in response to process context switch events.

Referring again to FIG. 3, in some embodiments, the TA rankings 350 and the TS rankings 360 may be provided to the scheduling manager 380 via the hardware (HW)-OS interface 370. In some embodiments, the HW-OS interface 370 may include registers and/or memory structures defined at the PE and/or thread level. Further, the HW-OS interface 370 may include enumeration registers and capabilities that allow the OS to discover and/or identify specific support and definition of PE information provided by the guide logic 300. The HW-OS interface 370 may also support interrupt capabilities to alert the OS about status and/or events of the guide logic 300. In some embodiments, the HW-OS interface 370 includes the hardware feedback interface (HFI) described in detail below.

In one or more embodiments, the scheduling manager 380 and/or the scheduler 390 may implemented in software (e.g., the operating system, a stand-alone application, etc.). The scheduling manager 380 may control the amount and/or format of the TA rankings 350 and TS rankings 360 provided to the scheduler 390. For example, the scheduling manager 380 may sort PE rankings, may filter PE rankings according to criteria (e.g., by age, by PE group, by thread group, by type, and so forth), may combine multiple PE rankings to generate combined PE rankings, may reformat PE rankings, and so forth.

In one or more embodiments, the scheduler 390 may use the TA rankings 350 and/or the TS rankings 360 to allocate threads to PEs (e.g., PEs 220 shown in FIG. 2). For example, the scheduler 390 may use PE information to schedule threads based on a current system priority, policy, or state (e.g., a specified balance between performance, efficiency, power consumption, and/or reliability priorities), based on thread specific characteristics (e.g., whether a thread is defined as a foreground task or a background task), to control temperature gradients and/or hot spots in PEs, and so forth.

In some embodiments, the TA rankings 350 and/or the TS rankings 360 may include indications to provide specific guidance to the scheduler 390. For example, a first PE may be assigned a rank value (e.g., “0”) to indicate that the first PE is to remain offline and thus should not be assigned any threads. In some embodiments, a PE may be taken offline to improve reliability of the PE, to delay a lifecycle limit of the PE, to remain within a specified power budget, to limit power use during a particular power state, to control temperature gradients and/or hot spots in PEs, and so forth.

In some embodiments, the output of the guide logic 300 may reflect groupings of PEs according to defined criteria. For example, the PEs listed in the TA rankings 350 may be grouped into performance classes (e.g., Class A with performance metric from 0 to 2, Class B with performance metric from 3 to 7, and Class C with performance metric from 8 to 10). Such groupings may allow the scheduler 390 to manage thread allocations by groups rather than by individual PEs.

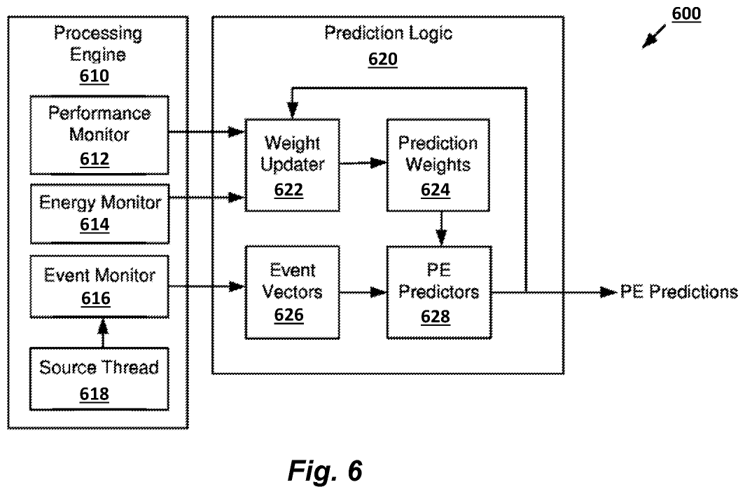

Referring now to FIG. 6, shown is a diagram of an example system 600 in accordance with one or more embodiments. As shown, the system 600 may include a processing engine (PE) 610 and prediction logic 620. The prediction logic 620 may correspond generally to some or all of the prediction logic 335 shown in FIG. 3A.

In some embodiments, the PE 610 may include a performance monitor 612, an energy monitor 614, and an event monitor 616. Further, the PE 610 may execute a source thread 618. The event monitor 616 may detect events of the PE 610 during execution of the source thread 618, such as memory instruction retirements, floating point instruction retirements, branch mispredictions, cache misses, pipeline stalls, and so forth. The performance monitor 612 may monitor performance characteristics of the PE 610 (e.g., instructions per clock cycle, percentage of maximum performance, etc.). The energy monitor 614 may monitor energy characteristics of the PE 610, such as power consumed per time period, power state, etc. In some embodiments, the performance monitor 612, the energy monitor 614, and/or the event monitor 616 may be implemented using hardware counters.

In one or more embodiments, the prediction logic 620 may include a weight updater 622, prediction weights 624, event vectors 626, and PE predictors 614. In some embodiments, the prediction logic 620 may receive indications of events from the event monitor 616 of PE 610, and may populate the event vectors 626 according to the received indications.

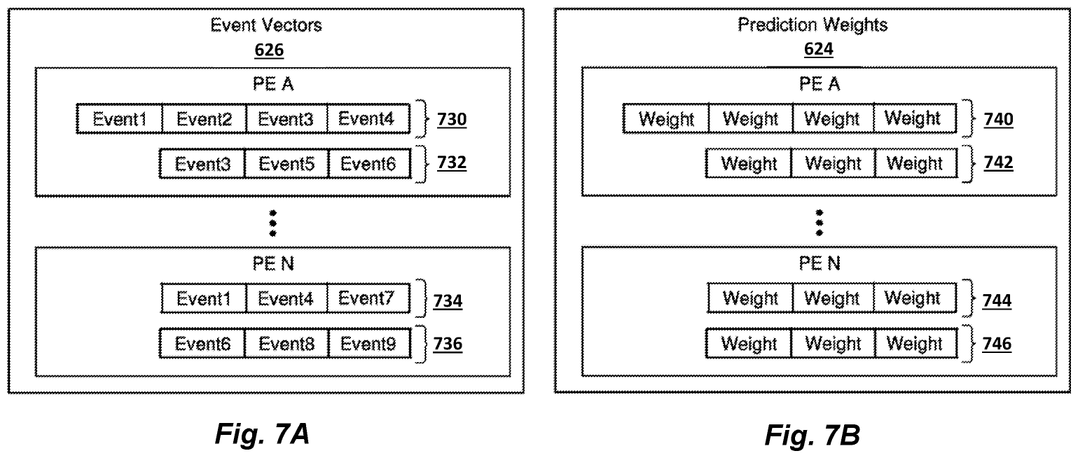

Referring now to FIG. 7A, shown is an example set of event vectors 626, in accordance with some embodiments. As shown, the event vectors 626 may include groups of vectors associated with various PEs (i.e., PE A to PE N). In some embodiments, each event vector 626 may include a unique number of fields, with each field being associated with a unique type of event. For example, a group of vectors for PE A may include a performance vector 630 and an energy vector 632. The performance vector 630 may include four fields, with each field indicating the occurrence of a particular event type. For example, a performance vector 630 may include a first field to store a number of memory instruction retirements, a second field to store a number of floating point instruction retirements, and so forth. The energy vector 632 may include three fields, with each field indicating the occurrence of a particular event type.

It is contemplated that the event vectors 626 for different PEs (or different PE types) may include fields for different event types, and may include different numbers of fields. For example, the group of vectors for PE N may include a performance vector 634 with three fields, and an energy vector 636 with three fields.

In some embodiments, the prediction weights 624 may be arranged in vectors similar to the event vectors 626. Referring now to FIG. 7B, shown is an example set of prediction weights 624 in accordance with some embodiments. As shown, the prediction weights 624 may include weight vectors 640, 642 for PE A. The weight vector 640 may include four weight fields that correspond to the performance vector 630. The weight vector 642 may include three weight fields that correspond to the energy vector 632 of PE A. Further, the weight vectors 644, 646 may correspond respectively to the performance vector 634 and energy vector 636 for PE B.

Referring again to FIG. 6, the PE predictors 628 may generate PE predictions for executing the source thread 618 on other PEs. Specifically, the PE predictors 628 may use events in the processing engine 610 (as populated in the event vectors 626) and the prediction weights 624 to predict characteristics of source thread 618 if executed on different PEs (i.e., on PEs other than PE 610). For example, the PE predictors 628 may provide performance predictions, power usage predictions, clock frequency predictions, and so forth. The PE predictors 628 may include linear predictors (e.g., linear regression), non-linear predictors, reinforcement logic models, and so forth.

In one or more embodiment, the PE predictors 628 may use a linear predictor to multiply an event vector 626 by a weight vector of the prediction weights 624, and determine a predicted value based on a sum of the element products. For example, the linear predictor may multiply each element of performance vector 630 of PE A (shown in FIG. 7A) by the corresponding element of weight vector 740 of PE A (shown in FIG. 7B), and may sum the products of all vector elements. The resulting sum may be a predicted performance value for the source thread 618 if it was executed on PE A. In some embodiments, the predicted performance may be provided to a scheduler (e.g., scheduler 390 shown in FIG. 3), and the scheduler may use this information to determine whether to move the source thread 618 to PE A from PE 610.

In one or more embodiment, the PE predictors 628 may provide predictions as to use a linear predictor to multiply an event vector 626 by a weight vector of the prediction weights 624, and determine a predicted value based on a sum of the element products. For example, the linear predictor may multiply each element of performance vector 730 of PE A by the corresponding element of weight vector 740 of PE A, and may sum the products of all vector elements. The resulting sum may be a predicted performance value for the source thread 618 if it was executed on PE A. In some embodiments, the predicted performance may be provided to a scheduler (e.g., scheduler 390), and the scheduler may use this information to determine whether to move the source thread 618 to PE A from PE 610.

In one or more embodiment, the weight updater 622 may compare PE predictions for a given PE to measured values to adjust the prediction weights 624. For example, assume that a scheduler receives predicted performance and energy characteristics for PE A, and then reallocates the source thread 618 to PE A. Assume further that PE A includes a performance monitor 612 and an energy monitor 614 that provide measured performance and energy characteristics for the execution of the source thread 618 on PE A. In this example, the weight updater 622 may compare the predicted and measured characteristics, and may adjust the prediction weights 624 based on this comparison. In this manner, the weight updater 622 may adjust the prediction weights 624 over time to improve the accuracy of future predictions of the prediction logic 620.

### Apparatus and Method for Adaptively Scheduling Work on Heterogeneous Processing Resources

When a new thread is to be executed, the embodiments described below identify the class associated with the thread (or the default class) and select the logical processor available within that class having the highest performance and/or best energy efficiency values. If the optimal logical processor is not available, one embodiment of the invention determines the next best logical processor and either schedules the new thread for execution on the next best performance or energy cores, or migrates a running thread from the optimal logical processor to make room for the new thread. In one embodiment, the decision to migrate or not migrate the running thread is based on a comparison of performance and/or energy values associated with the new thread and the running thread. In one implementation, it is up to the OS to choose the appropriate scheduling method per software thread, ether based on energy consumption (e.g., for low power environments) or best performance

As used herein, a logical processor (LP) may comprise a processor core or a specified portion of a processor core (e.g., a hardware thread on the processor core). For example, a single threaded core may map directly to one logical processor whereas an SMT core may map to multiple logical processors. If the SMT core is capable of simultaneously executing N threads, for example, then N logical processors may be mapped to the SMT core (e.g., one for each simultaneous thread). In this example, N may be any value based on the capabilities of the SMT core (e.g., 2, 4, 8, etc). Other execution resources may be associated with a logical processor such as an allocated memory space and/or portion of a cache.

In some case, the platform may include a mix of cores, some of which include SMT support and some of which do not. In some cases, the performance and energy results of a core that has SMT support may be better than results on a non-SMT core when running more than one software thread. In other cases, the non-SMT core may provide better performance/energy results. Thus, in one embodiment, the scheduling order is: (1) schedule first on the core with highest performance/energy; (2) second, scheduled on the core with the lower perf/energy capabilities; and (3) finally, schedule on the core with SMT support.

It has been observed that random scheduling of threads from different types of workloads on a set of heterogeneous cores can result in lower performance than would be possible when compared with more intelligent allocation mechanisms.

In some embodiments described below, the “small cores” are Atom processors and the “big cores” are Core i3, i5, i7, or i9 cores. These cores may be integrated on the same die and/or interconnected on the same processor package. Note, however, that the underlying principles of the invention are not limited to any particular processor architecture or any specific type of processor or core.

At the same amount of power, a small core such as an Atom processor may provide higher performance than that of a big core. This power/performance cross point is a function of the ratio of big core IPC over small core IPC (i.e., IPC_{B}/IPC_{S}) which is particularly impacted for single threads or a small number of threads. The different IPC_{B}/IPC_{S} values also impact the potential to reduce energy in order to improve battery life. As the ratio decreases, scheduling work on big cores becomes less attractive from an energy savings perspective.

In one embodiment, different classes are defined for different types of workloads. In particular, one embodiment defines a first class of workloads with an IPC_{B}/IPC_{S} ratio below 1.3, a second class of workloads with an IPC_{B}/IPC_{S} ratio below 1.5, and a third class of workloads with an IPC_{B}/IPC_{S} ratio above (or equal to) 1.5.

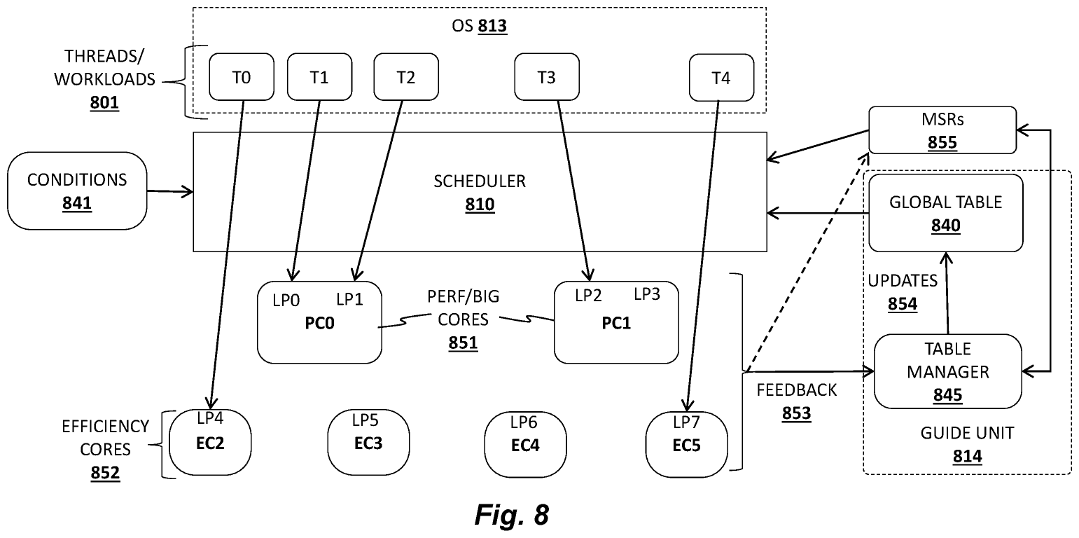

One embodiment of the invention maintains a global view of the performance and energy data associated with different workloads and core types as well as different classes of big/little IPC values. As shown in FIG. 8, in one implementation, this is accomplished with a global table 840 which stores the performance, energy, and other data for each type of core 851-852 and/or logical processor (LP). The global table 840 and other logic shown in FIG. 8 (e.g., table manager 845) may be implemented in hardware or by a combination of hardware and software.

For the purpose of illustration, two types of cores are shown in FIG. 8: performance cores 851 (sometimes referred to as “big” cores) and efficiency cores 852 (sometimes referred to as “little” cores). Note, however, that various additional cores and alternate combinations of big/little cores may be used. For example, some embodiments described below implement a disaggregated architecture in which an SoC/IO tile includes one or more cores (which may be selected during low utilization conditions so that the compute tiles can be moved into low power states).

In one embodiment, a scheduler 810 maps threads/workloads 801 to cores 851-852 and/or logical processors LP0-LP7 based on current operating conditions 841 and the performance and energy data from a global table 840 (described in greater detail below). In one embodiment, the scheduler 810 relies on (or includes) a guide/mapping unit 814 to evaluate different thread/logical processor mappings in view of the global table 840 to determine which thread should be mapped to which logical processor. The scheduler 810 may then implement the mapping. The scheduler 810, guide/mapping unit 814, table manager 845, and global table 840 may be implemented in hardware/circuitry programmed by software (e.g., by setting register values) or by a combination of hardware and software.

The currently detected operating conditions 841 may include variables related to power consumption and temperature, and may determine whether to choose efficiency values or performance values based on these conditions. For example, if the computing system is a mobile device, then the scheduler 810 may perform mapping using efficiency options more frequently, depending on whether the mobile device is currently powered by a battery or plugged into an electrical outlet. Similarly, if the battery level of the mobile computing system is low, then the scheduler 810 may tend to favor efficiency options (unless it would be more efficient to use a large core for a shorter period of time). As another example, if a significant amount of power of the overall power budget of the system is being consumed by another processor component (e.g., the graphics processing unit is performing graphics-intensive operations), then the scheduler 810 may perform an efficiency mapping to ensure that the power budget is not breached.

One embodiment of a global table 840, shown below as Table B, specifies different energy efficiency and performance values for each core 851-852 within each defined class (e.g., Eff₀₂, Perf₁₁, etc). The cores are associated with a logical processor number (LP0-LPn) and each logical processor may represent any type of physical core or any defined portion of a physical core, including an entire core.

In one embodiment, a table manager 845 performs updates to the global table 840 based on feedback 853 related to the execution of the different threads/workloads 801. The feedback may be stored in one or more MSRs 855 and read by the table manager 845.

The first time a thread/workload is executed, it may be assigned a default class (e.g., Class 0). The table manager 845 then analyzes the feedback results when executed in the default class, and if a more efficient categorization is available, the table manager 845 assigns this particular thread/workload to a different class. In one embodiment, the feedback 853 is used in one embodiment to generate an index into the global table 840. The classes in this embodiment are created based on ranges of IPC_{B}/IPC_{S} as described above.

TABLE B

| Class 2 | | Class 1 | | Class 0 | | |
|---|---|---|---|---|---|---|
| Energy | | Energy | | Energy | | |
| Eff. | Perf | Eff. | Perf | Eff. | Perf | Cores |
| Eff₀₂ | Perf₀₂ | Eff₀₁ | Perf₀₁ | Eff₀₀ | Perf₀₀ | LP0 |
| Eff₁₂ | Perf₁₂ | Eff₁₁ | Perf₁₁ | Eff₁₀ | Perf₁₀ | LP1 |
| | | | | | | . . . |
| Effₙ₂ | Perfₙ₂ | Effₙ₁ | Perfₙ₁ | Effₙ₀ | Perfₙ₀ | LPn |

In one embodiment, the scheduler 810 uses the global table 840 and associated information to realize a global view of the different core types and corresponding performance and energy metrics for different classes. Extensions to existing schedulers may add new columns per class type. In one embodiment, the different classes enable an operating system or software scheduler to choose different allocation mechanisms for a workload based on the class of that workload.

In one embodiment, Class 0 is defined as a default class which maintains legacy support and represents the median case of the curve. In this embodiment, the guide/mapping unit 814 and/or scheduler 810 uses this default class when no valid data has been collected for the current thread. As described above, the table manager 845 may evaluate feedback 853 related to the execution of the thread in the default class and provide an update 854 to the global table 840 if a different class is more appropriate. For example, it may categorize the thread into Class 1 if the IPC_{B}/IPC_{S} ratio of the thread is greater than a first specified threshold (e.g., 1.5) and categorize the thread into Class 2 if the IPC_{B}/IPC_{S} ratio is less than a second threshold (e.g., 1.3).

The different columns per class in the global table 840 may be specified via one or more control registers. For example, in an x86 implementation, the columns may be enumerated by CPUID[6].EDX[7:0] (e.g., for a table with 7-1 different columns per class). The operating system (OS) 813 and/or scheduler 810 can learn which line is relevant for each logical processor by one or more bits in EDX (e.g., CPUID.6.EDX[31-16]=n, where n is the index position which the logical processor's line is set) and can also determine the number of classes via a value in EDX (e.g., indicated by CPUID.6.EDX[11:8]). The OS can calculate the location of each logical processor line in the HGS table by the following technique:

If advanced hardware guided scheduling (e.g., HGS+) is enabled

$$HGS Base Addr + 8 + FLOOR ( ( \# of classes * \# of support capabilities bitmap set bits - 1 ) / 8 + 1 ) * 8 * ( LPn row index + 1 )$$

else (advanced hardware guided scheduling is disabled and basic hardware guided scheduling is enabled)

$$HGS Base Addr + 8 + \underline{8} * ( LPn row index + 1 )$$

The size of the HGS table can be enumerated by CPUID[6].EDX[11:8]

The OS can enumerate about the legacy HGS basic support from CPUID[6].EAX[19] and about the newer HGS+ support from CPUID[6].EAX[23]

In one embodiment, the performance capability values are non-semantic and do not necessarily reflect actual performance.

The performance columns in the table store relative performance values between the logical processors represented in the different rows. One embodiment of the interface provides for sharing of lines with a plurality of different logical processors that belong to the same core type, thereby providing for reasonable comparisons.

For each defined class, the ratio of performance values between cores within the same column such as

$${Perf}_{ijk} = \frac{{Perf}_{ik}}{{Perf}_{jk}}$$

provides a rough comparison but does not provide an actual performance value. Similarly, the ratio of energy efficiency values in a column such as

$${Enery}_{ijk} = \frac{{Energy}_{ik}}{{Energy}_{jk}}$$

for each logical processor provides a relative comparison, but does not reflect the actual energy consumed.

In one embodiment, the table manager 845 updates the global table 840 when the relative performance or energy value has experienced a significant change that can impact scheduling, such as when the order between the cores or the difference between the cores changes. These changes can be specified in one or more columns and, for each column that was updated, the column header is marked to indicate that the change was made. In addition, a status bit may be set in a control register to indicate that an update occurred. For example, in some x86 implementations, the status bit is set in a particular model-specific register (MSR).

The global table 840 can be updated dynamically as a result of physical limitations such as power or thermal limitations. As a result, part or all of the performance and energy class value columns may be updated and the order in which a core with the best performance or energy is selected may be changed.

When updates like this happen, the hardware marks the column(s) that was updated in the global table 840 (e.g., in the column header field). In addition, in one embodiment, the time stamp field is updated to mark the last update of the table.

In addition, the thermal status registers may also be updated and, if permitted by the OS, the thermal interrupts. An interrupt may also be generated to notify the OS about the changes. Following the setting of the thermal updates, the table manager 845 may not update the global table 840 any more until permitted by the OS (e.g., the OS clears the log bit). This is done in order to avoid making changes while the OS is reading the table.

Given that that different classes may be impacted in a different way for different physical limitations, one embodiment of the invention provides the ability to update only selected table classes. This configurability provides for optimal results even when the physical conditions are changed. Following an indication that the order of the class performance or energy is changed, the OS may reschedule software threads in accordance with each software thread's class index.

In one embodiment, in response to detected changes, a thread-level MSR 855 reports the index into the current thread column to the OS 813 and/or scheduler 810 as well as a valid bit to indicate whether the reported data is valid. For example, for a thread-level MSR 855, the following bits may provide indications for RTC (run time characteristics):
Bit 7:0—Application class index of the table, representing the latest “Application Class” executed on this hardware thread;
Bit 63—Valid bit; if set to 1, the OS/scheduler can use it, otherwise the class index should be ignored

In one embodiment, the valid bit is set or cleared based on the current state and operational characteristics of the microarchitecture. For example, the data may not be valid following a context switch of a new thread 801 until the hardware (e.g., the table manager 845) can evaluate or otherwise determine the characteristics of the new thread. The valid bit may also be adjusted when transitioning between specific security code flows. In circumstances where the valid bit is not set, the scheduler 810 may ignore the feedback data and use the last index known to be valid.

In one embodiment, the OS 813 and/or scheduler 810 reads this MSR 855 when swapping out a context in order to have the most up-to-date information for the next context swapped in. The OS 813 and/or scheduler 810 can also read the MSR 855 dynamically during runtime of the current software thread. For example, the OS/scheduler may read the MSR 855 on each tick of the scheduler 810.

In order for the hardware (e.g., the table manager 845) to have the time required to learn about the new thread and ensure the validity of the report index after the new context is swapped in, one embodiment of the invention provides the option to save and restore the microarchitectural metadata that includes the history of the index detection. In one implementation, this is accomplished using the MSR 855 which can be ether read or written as a regular MSR or by utilizing the processor's save and restore mechanisms (e.g., such as XSAVES/XRESROS on an x86 implementation). For example:
Thread level Scope MSR (Read/Write)
   Bit 63:0—software thread, hardware feedback history metadata.
      In one implementation, the OS 813 and/or scheduler 810 reads this metadata when swapping in the thread and updates it during execution and/or when swapping out the same thread.

In some implementations where metadata is not supported, prediction history is still need to be reset during a context switch in order to enable valid feedback that will not be impacted from previous execution of the software thread. This reset data may be enabled if the OS is configured to “opt-in” support of history reset every time that IA32_KENTEL_GS_BASE is executed. Other OS-based context switch techniques that include H/W architecture methods may also be used in order to reset the hardware guided scheduling prediction history during context switches. In another embodiment, a specific MSR is enabled with a control bit that forces resetting the history. This control MSR can be ether saved and restored by XSAVES/XRESORS or manually used by the OS on every context switch. other option can be that every time that the value of this MSR be zero, write or restore this MSR will reset the hardware guided scheduling history, Another embodiment resets the history via a thread level config MSR (as described below) that enables the option for the OS to manually reset the history.

The OS 813 and/or scheduler 810 can enable and disable the extension of the global table 840 via an MSR control bit. This may be done, for example, to avoid conflicts with legacy implementations and/or to avoid power leakage. For example, the operating system may dynamically disable the features described herein when running on legacy systems. While disabled, the feedback MSR thread level report is invalid. Enabling can be done at the logical processor level in order to provide, for example, the VMM the option to enable the techniques described herein for part of an SoC based on each VM usage mode (including whether the VM supports these techniques).

In one particular embodiment, the thread level configuration is implemented as follows:
IA32_HW_FEEDBACK_THREAD_CONFIG provides Read/Write thread level scope (0x17D3)
   Bit 0: Enables logical processor support for the scheduling techniques described herein. When set to 1, enables the support of the thread level hardware feedback and resets its history. Default: 0.
   Bit 1: WRMSR_IA32_KERNEL_GS_BASE_CLEAR_HGS_HISTORY, when set, WRMSR of IA32_KERNEL_GS_BASE resets the prediction history. Default: 0
   Bit 2: Reset the history command bit, always reads as 0, reset the prediction history when set (written with ‘1’)

In one implementation, the enabling and disabling is performed via a package-level MSR. For example, in an x86 implementation the following MSR may be specified:
IA32_HW_FEEDBACK_CONFIG
   Bit 0—Enable. When set to 1, this bit enables the hardware feedback interface described herein. The default is 0.
   Bit 1—Enable. When set to 1, this bit enables multiple class support. The extra classes columns in the global table 840 are valid only while bit 1 is set. Setting this bit enables the thread level feedback 853 sent to the MSR 855 to support valid report class indices.

As mentioned, when a new thread is to be executed, embodiments of the invention identify the class associated with the thread (or the default class) and select the logical processor (LP) available within that class having the highest performance and/or best energy efficiency values (depending on the current desired power consumption). If the optimal logical processor is not available, one embodiment of the invention determines the next best logical processor and either schedules the new thread for execution on the next best logical processor, or migrates a running thread from the optimal logical processor to make room for the new thread. In one embodiment, the decision to migrate or not migrate the running thread is based on a comparison of performance and/or energy values associated with the new thread and the running thread.

For a “High Priority” thread, the relevant column is determined based on the thread class index (k). In one embodiment, the index is provided by a feedback MSR 855. On the thread performance class column (k), a row is identified with the highest performance value. If the corresponding logical processor is free, then the thread is scheduled on this logical processor.

Alternatively, if all highest performance logical processors are occupied, the performance class column (k) is then searched for a free logical processor, working from highest to lowest performance values. When one is located, the thread may be scheduled on the free logical processor or a running thread may be migrated from the preferred logical processor and the new thread may be scheduled on the preferred logical processor.

In this embodiment, the scheduler 810 may evaluate whether to migrate an existing thread to a different logical processor to ensure a fair distribution of processing resources. In one embodiment, comparisons are made between the different performance values of the different threads and logical processors to render this decision, as described below.

Thus, in one embodiment, when a new thread must be scheduled for execution on a logical processor, the index of the new thread (I) is used to search for a free logical processor in the performance class associated with the new thread (e.g., one of the columns in the global table 840). If there is an idle logical processor with the highest performance value then the new thread is scheduled on the idle logical processor. If not, then a secondary logical processor is identified. For example, the scheduler may search down the column in the global table 840 to identify the logical processor having the second highest performance value.

An evaluation may be performed to determine whether to migrate any running threads from a logical processor which would be a highest performance LP for the new thread to a different logical processor to make room for the new thread on the highest performance logical processor. In one embodiment, this evaluation involves a comparison of the performance values of the running thread and the new thread on the highest performance logical processor and one or more alternate logical processors. For the new thread, the alternate logical processor comprises the secondary processor (i.e., which will provide the next highest performance for the new thread). For the running thread, the alternate logical processor may comprise the secondary logical processor (if it will provide the second highest performance) or another logical processor (if it will provide the second highest performance).

In one particular implementation, the ratio of the performance on highest performance LP over performance on the alternate LP for both the new thread and the running thread. If the ratio for the new thread is greater, then the running thread is migrated to its alternate logical processor. if the ratio for the running thread is greater, then the new thread will be scheduled on its alternate logical processor. The following are example ratio calculations:

New Thread Comp Value=Perf_{new thread highest}/Perf_{new thread alternate}

Running Thread Comp Value=Perf_{running thread highest}/Perf_{running thread alternate}

If the above ratio is greater for the new thread, then the running thread is migrated to its alternate logical processor (i.e., the LP on which it will have the second highest performance) and new thread is scheduled to execute on its highest performance logical processor. If the ratio is greater for the running thread, then the new thread is scheduled on the secondary LP (which will provide it with the second highest performance).

In one embodiment, when energy efficiency is selected as the determining factor, the same techniques as described above are implemented to determine the logical processor for the new thread but using the efficiency class data from the global table 840 instead of the performance class data. For example, the index of the new thread (I) is used to search for a free logical processor in the efficiency class associated with the new thread. If there is an idle logical processor with the highest efficiency value, then the new thread is scheduled on the idle logical processor. If not, then a secondary logical processor is identified. For example, the scheduler may search down the column in the global table 840 to identify the logical processor having the second best efficiency value. An evaluation is performed to determine whether to migrate any running threads from a logical processor which would be a highest efficiency LP for the new thread to a different logical processor to make room for the new thread. To render this decision, efficiency ratios may be determined as described above for performance:

New Thread Comp Value=Eff_{new thread highest}/Eff_{new thread alternate}

Running Thread Comp Value=Eff_{running thread highest}/Eff_{running thread alternate}

As with performance, the thread with the larger index is executed on the highest efficiency logical processor, while the other thread is run (or migrated) to an alternate logical processor.

The above analysis may be performed to allocate and migrate threads in the same or different performance and efficiency classes. If the new thread has a different class index as the other threads in busy logical processors, then the performance or efficiency ratio is determined using the highest performance or efficiency value over the next best performance or efficiency value for each of the threads currently running and/or new threads to be scheduled. Those threads with the highest ratios are then allocated to the highest performance or efficiency logical processors while the others are scheduled (or migrated) on the next best performance or efficiency logical processors.

In one embodiment, in order to migrate a running thread, the ratio of the new thread must be greater than the running thread by a specified threshold amount. In one embodiment, this threshold value is selected based on the amount of overhead required to migrate the running thread to the new logical processor (e.g., the processing resources, energy, and time consumed by the migration). This ensures that if the ratio of the new thread is only slightly higher than that of the running thread, then the running thread will not be migrated.

In one embodiment, the scheduler 810 performs a thread allocation analysis periodically (e.g., every 15 ms, 20 ms, etc) to perform the above performance and/or efficiency comparisons. If a higher performance or improved energy efficiency option is available, it will then migrate one or more threads between logical processors to achieve this higher performance or higher efficiency option.

Some existing scheduling implementations provide a global view of the performance and energy characteristics of different core/processor types. However, these implementations assume the same level of big/little IPCs and take the median value of all possible traces while ignoring the actual differences between different types of software threads. The embodiments of the invention address this limitation by considering these differences.

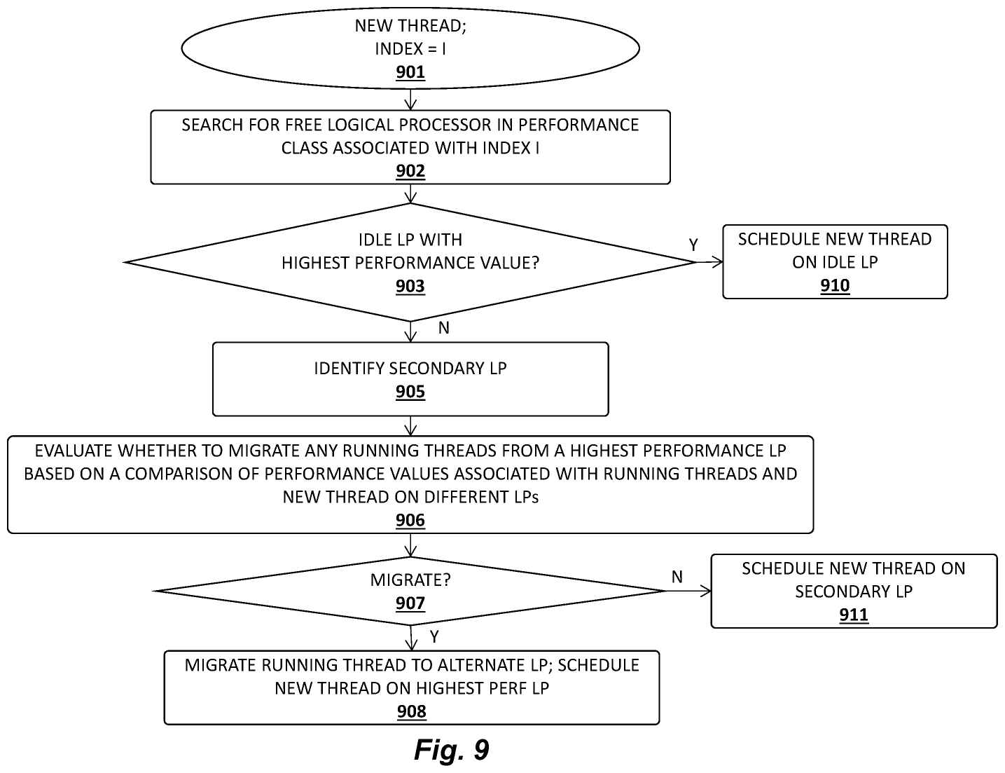

FIG. 9 illustrates a method in accordance with one embodiment of the invention. The method may be implemented on the architectures described above, but is not limited to any particular architecture.

At 901, a new thread is received and must be scheduled for execution on a logical processor. At 902, the index of the new thread (I) is used to search for a free logical processor in the performance class associated with the new thread (e.g., one of the columns in the global table 840).

If there is an idle logical processor with the highest performance value, determined at 903, then the new thread is scheduled on the idle logical processor at 910. If not, then at 905, a secondary logical processor is identified at 905. For example, the scheduler may search down the column in the global table 840 to identify the logical processor having the second highest performance value.

At 906, an evaluation is performed to determine whether to migrate any running threads from a logical processor which would be a highest performance LP for the new thread to a different logical processor to make room for the new thread on the highest performance logical processor. In one embodiment, this evaluation involves a comparison of the performance values of the running thread and the new thread on the highest performance logical processor and one or more alternate logical processors. For the new thread, the alternate logical processor comprises the secondary processor (i.e., which will provide the next highest performance for the new thread). For the running thread, the alternate logical processor may comprise the secondary logical processor (if it will provide the second highest performance) or another logical processor (if it will provide the second highest performance).

In one particular implementation, the ratio of the performance on highest performance LP over performance on the alternate LP for both the new thread and the running thread. If the ratio for the new thread is greater, then the running thread is migrated to its alternate logical processor. if the ratio for the running thread is greater, then the new thread will be scheduled on its alternate logical processor. The following are example ratio calculations:

New Thread Comp Value=Perf_{new thread highest}/Perf_{new thread alternate}

Running Thread Comp Value=Perf_{running thread highest}/Perf_{running thread alternate}

If the above ratio is greater for the new thread, determined at 907, then the running thread is migrated to its alternate logical processor at 908 (i.e., the LP on which it will have the second highest performance) and new thread is scheduled to execute on its highest performance logical processor. If the ratio is greater for the running thread, then the new thread is scheduled on the secondary LP (which will provide it with the second highest performance).

In one embodiment, when energy efficiency is selected as the determining factor, the same techniques as described above are implemented to determine the logical processor for the new thread but using the efficiency class data from the global table 840 instead of the performance class data. For example, at 902, the index of the new thread (I) is used to search for a free logical processor in the efficiency class associated with the new thread. If there is an idle logical processor with the highest efficiency value, determined at 903, then the new thread is scheduled on the idle logical processor at 910. If not, then at 905, a secondary logical processor is identified at 905. For example, the scheduler may search down the column in the global table 840 to identify the logical processor having the second best efficiency value. Then, at 906, an evaluation is performed to determine whether to migrate any running threads from a logical processor which would be a highest efficiency LP for the new thread to a different logical processor to make room for the new thread. To render this decision, efficiency ratios may be determined as described above for performance:

New Thread Comp Value=Eff_{new thread highest}/Eff_{new thread alternate}

Running Thread Comp Value=Eff_{running thread highest}/Eff_{running thread alternate}

As with performance, the thread with the larger index is executed on the highest efficiency logical processor, while the other thread is run (or migrated) to an alternate logical processor.

The above analysis may be performed to allocate and migrate threads in the same or different performance and efficiency classes. If the new thread has a different class index as the other threads in busy logical processors, then the performance or efficiency ratio is determined using the highest performance or efficiency value over the next best performance or efficiency value for each of the threads currently running and/or new threads to be scheduled. Those threads with the highest ratios are then allocated to the highest performance or efficiency logical processors while the others are scheduled (or migrated) on the next best performance or efficiency logical processors.

In one embodiment, in order to migrate a running thread, the ratio of the new thread must be greater than the running thread by a specified threshold amount. In one embodiment, this threshold value is selected based on the amount of overhead required to migrate the running thread to the new logical processor (e.g., the processing resources, energy, and time consumed by the migration). This ensures that if the ratio of the new thread is only slightly higher than that of the running thread, then the running thread will not be migrated.

In one embodiment, the scheduler 810 performs a thread allocation analysis periodically (e.g., every 15 ms, 20 ms, etc) to perform the above performance and/or efficiency comparisons. If a higher performance or improved energy efficiency option is available, it will then migrate one or more threads between logical processors to achieve this higher performance or higher efficiency option.

Some existing scheduling implementations provide a global view of the performance and energy characteristics of different core/processor types. However, these implementations assume the same level of big/little IPCs and take the median value of all possible traces while ignoring the actual differences between different types of software threads. The embodiments of the invention address this limitation by considering these differences.

### Apparatus and Method for Dynamic Core Management

Various embodiments of the invention evaluate different types of core parking and core consolidation hints and other relevant conditions to generate a resolved hardware-guided scheduling (HGS) hint, while architecturally meeting the requirements of dynamic core parking scenarios that may coexist in the processor. As used herein, a “hint” includes any information which can be used when rendering performance and/or power management decisions. Hints can be encoded in messages (e.g., such as performance and power management requests) and/or may include updates to values stored in various registers, caches, or addressable memory. For example, certain hints may be generated by updating dedicated power management registers or various types of “mailbox” registers.

Some embodiments coordinate with the OS scheduler to determine a specific set of cores to be parked or consolidated in view of runtime metrics such as core utilization, thread performance, memory dependencies, core topology, and voltage-frequency curves. At least one embodiment allocates a power budget to different IP blocks in the processor to deliver a desired performance, recognizing the differences in the relative priority of each type of compute block as well as the differences in the power/frequency and frequency/performance relationships in each of the compute blocks. Some implementations allocate the power budget in view of a disaggregated, heterogeneous processor architecture with separate compute tiles, SoC tiles, graphics tiles, and IO tiles.

As used herein, a “parking” hint refers to a request or recommendation to avoid using specific cores (e.g., thereby “parking” the cores). The parking hints and other types of hints described herein may be communicated via a hardware feedback interface (HFI) storage such as a register (e.g., an MSR) or memory region allocated by the operating system (OS).

Currently, parking hints have the disadvantage of hiding the performance capabilities of the parked cores from the OS. As a result, when the OS has high priority work that no longer fits within the available cores, and it wants to run that work on a high performance core, it has no information as to what core to use.

A “consolidation” hint is a request generated to consolidate efficient work to a subset of the cores on the processor. In existing implementations, the OS may erroneously interpret this hint as a request to consolidate all work on this subset of cores, even if lower priority work must be deferred. A particular type of consolidation, referred to as “below PE consolidation” (BPC) attempts to contain the number of cores to bring the per-core frequency above a limit when the system is frequency limited.

Processor “survivability” features are activated when there are thermal and/or electrical reasons to reduce the number of cores to avoid shut down of the processor. In some implementations, survivability causes cores to be parked rather than contained to ensure that the OS will not start using more cores than hinted. In some embodiments, parking starts with the most power-consuming cores. For example, in the disaggregated architectures described below, the parking order may be: highest performance big cores (e.g., ULT big cores), big cores, compute die small cores (e.g., compute die Atom cores), and SoC die small core (e.g., SoC die Atom cores). In the final stages, the SoC may run out of a single SoC die core. In one embodiment, when only a single efficient core is active, the survivability feature is deactivated. Because this feature is critical, it overrides other hints and/or configuration settings; at the same time this condition is not expected to occur very often.

In some embodiments, because the goal of both below BPC and survivability is to reduce the number of cores, when BPC and survivability both are active, BPC is bypassed to avoid aggressive constraining when not required.

Various hardware-based techniques may be used for optimizing active cores. For example, with Hardware Guided Scheduling (HGS) (e.g., as implemented on hardware guide unit 814 described above), hints may be provided to the OS to not schedule work on a subset of cores (core parking) and/or hints to only schedule the work on a subset of cores (core consolidation), with the goal of improving overall power and performance (PnP). Some embodiments of the invention determine a specific set of cores to be parked or consolidated in view of the disaggregated architecture of the processor, various runtime metrics (e.g., core utilization, temperature), thread performance, memory dependencies, core topology, and voltage-frequency curves.

### Examples of Heterogeneous Processors and Power Management Architectures

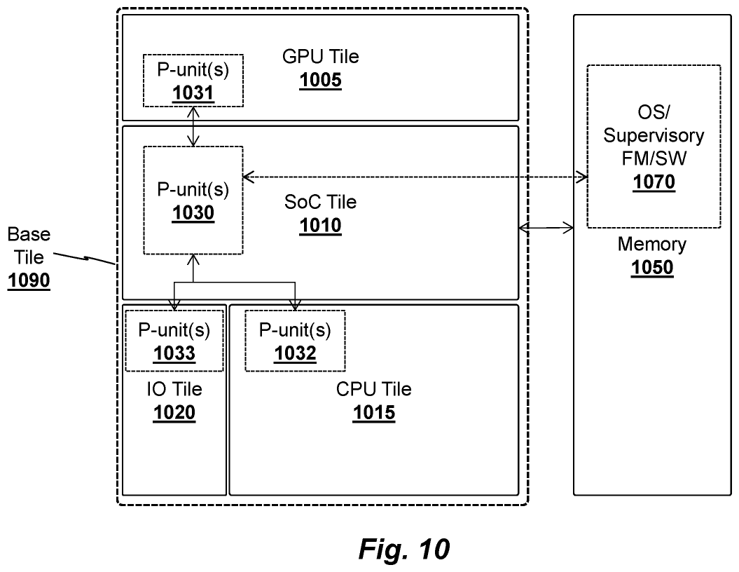

FIG. 10 illustrates an example of a processor with a disaggregated architecture comprising an SoC tile 1010, a CPU tile 1015, A GPU tile 1005, and an IO tile 1020 which are integrated on a common base tile 1090 coupled to a package substrate. In some embodiments, each tile comprises a separate die or chip which communicates with other dies/chips over horizontal and/or vertical interconnects (e.g., through-silicon vias). The SoC tile 1010 includes a memory controller to couple the processor to system memory 1050 and provides various other SoC-level functions such as coherent fabric interconnects between the various IP blocks, a display engine, and a low-power IP block which remains operational, even when the processor enters into low power states.

Some embodiments implement a distributed power management architecture comprising a plurality of power management units (P-units) 1030-1033 distributed across the various dies 1005, 1010, 1015, 1020, respectively. In certain implementations, the P-units 1030-1033 are configured as a hierarchical power management subsystem in which a single P-unit (e.g., the P-unit 1030 on the SoC tile 1010 in several examples described herein) operates as a supervisor P-unit which collects and evaluates power management metrics provided from the other P-units 1031-1033 to make package-level power management decisions and determine power/performance states at which each of the tiles and/or individual IP blocks are to operate (e.g., the frequencies and voltages for each of the IP blocks).

The supervisor P-unit 1030 communicates the power/performance states to the other P-units 1031-1033, which implement the power/performance states locally, on each respective tile. In some implementation, the package-wide power management decisions of the supervisor P-unit 1030 include decisions described herein involving core parking and/or core consolidation.

An operating system (OS) and/or other supervisory firmware (FW) or software (SW) 1070 may communicate with the supervisory P-unit 1030 to exchange power management state information and power management requests (e.g., such as the “hints” described herein). The hardware guide unit 814 and associated tables may be implemented in the supervisor P-unit 1030 and/or the SoC tile 1010. In some implementations described herein, the communication between the OS/supervisory FW/SW 1070 and the P-unit 1030 occurs via a mailbox register or set of mailbox registers. In some embodiments, a Baseboard Management Controller (BMC) or other system controller may exchange power control messages with the supervisory P-unit 1030 via these mailbox registers or a different set of mailbox registers.

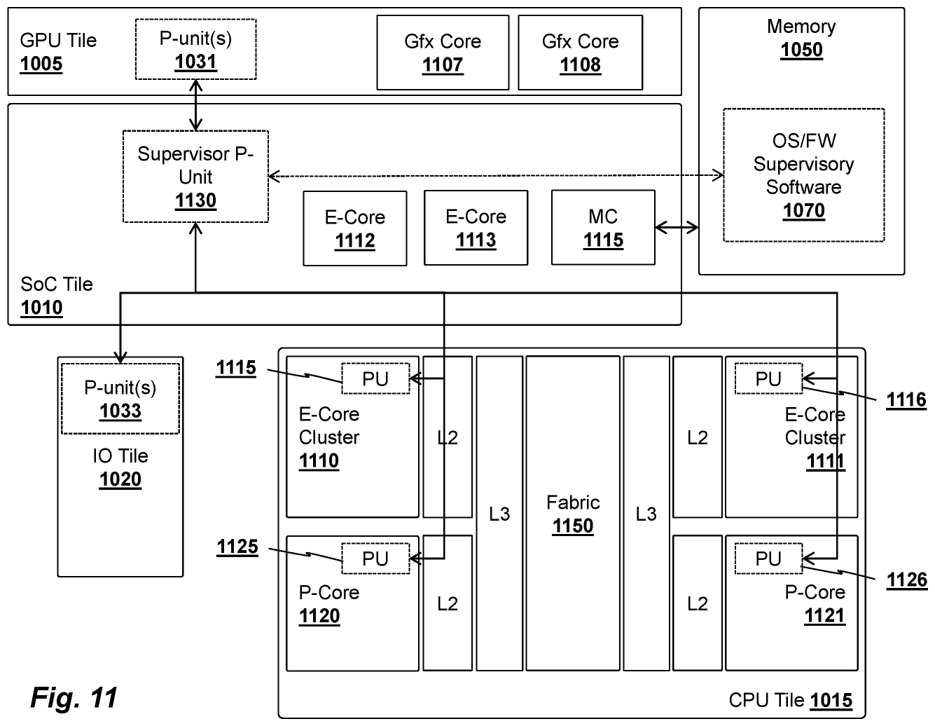

FIG. 11 illustrates additional details of one embodiment of a CPU tile 1015, which includes a heterogeneous set of cores including efficiency cores (E-cores) arranged into two E-core clusters 1110-1111 and a plurality of performance cores (P-cores) 1120-1121. Some embodiments of the SoC tile 1010 include a set of E-cores 1112-1113 and a memory controller 1115 to couple the processor to system memory 1050 (e.g., DDR DRAM memory, HBM memory, etc). Similarly, the GPU tile 1005 includes a plurality of graphics cores 1107-1108 which may be managed in the same manner as the P-cores and E-cores as described herein.

The E-cores in the E-core clusters 1110-1111 and the SoC tile 1010 are physically smaller (with multiple E-cores fitting into the physical die space of a P-core), are designed to maximize CPU efficiency, measured as performance-per-watt, and are typically used for scalable, multi-threaded performance. The E-cores work in concert with P-cores 1120-1121 to accelerate tasks which tend to consume a large number of cores. The E-cores are optimized to run background tasks efficiently and, as such, smaller tasks are typically offloaded to E-cores (e.g., handling Discord or antivirus software)—leaving the P-cores 1120-1121 free to drive high performance tasks such as gaming or 3D rendering.

The P-cores 1120-1121 are physically larger, high-performance cores which are tuned for high turbo frequencies and high IPC (instructions per cycle) and are particularly suited to processing heavy single-threaded work. In some embodiments, the P-cores are also capable of hyper-threading (i.e., concurrently running multiple software threads).

In the illustrated embodiment, separate P-units 1115-1116 are associated with each E-core cluster 1110-1111, respectively, to manage power consumption within each respective E-core cluster in response to messages from the supervisor P-unit 1130 and to communicate power usage metrics to the supervisor P-unit 1130. Similarly, separate P-units 1125-1126 are associated with each P-core 1120-1121, respectively, to manage power/performance of the respective P-core in response to the supervisor P-unit 1130 and to collect and communicate power usage metrics to the supervisor P-unit 1130.

In one embodiment, the local P-units 1115-1116, 1125-1126 manage power locally by independently adjusting frequency/voltage levels to each E-core cluster 1110-1111 and P-core 1120-1121, respectively. For example, P-units 1115-1116 control digital linear voltage regulators (DLVRs) and/or fully integrated voltage regulators (FIVRs) to independently manage the frequency/voltage applied to each E-core within the E-core clusters 1110-1111. Similarly, P-units 1125-1126 control another set of DLVRs and/or FIVRs to independently manage the frequency/voltage applied to each P-core 1120-1121. The graphics cores 1107-1108 and/or E-cores 1112-1113 may be similarly controlled via DLVRs/FIVRs. In these implementations, the frequency/voltage associated with a first core may be dynamically adjusted independently—i.e., without affecting the frequencies/voltages of one or more other cores. The dynamic and independent control of individual E-cores/P-cores provides for processor-wide Dynamic Voltage and Frequency Scaling (DVFS) controlled by the supervisor P-unit 1130.

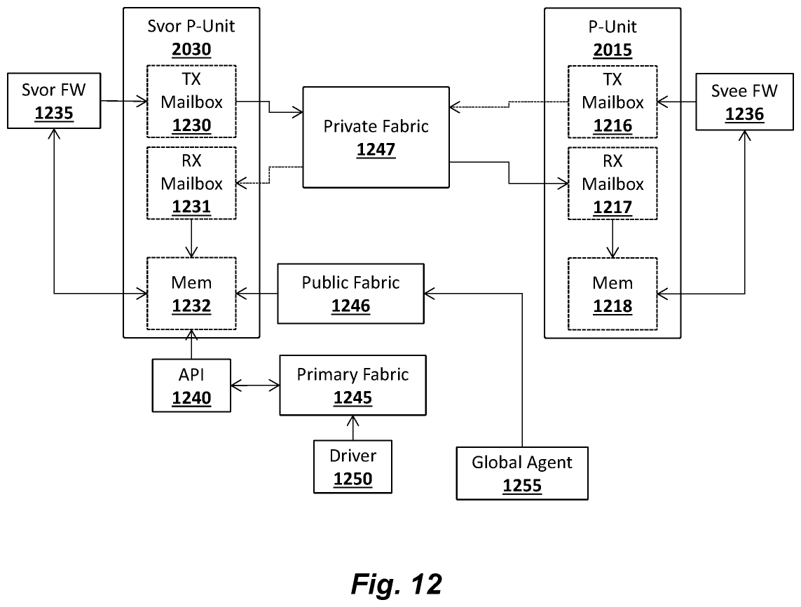

As illustrated in FIG. 12, in some implementations, the supervisor P-unit 1130 and other P-units 1115 in the processor communicate via a private fabric 1247. The supervisor P-unit 1130 sends power management messages to other P-units 1115 via a transmit (TX) mailbox 1230 and receives messages from the other P-units via a receive (RX) mailbox 1231. Each of the other P-units (such as P-unit 1115, shown for simplicity) includes a TX mailbox 1216 for transmitting messages and an RX mailbox 1217 for receiving messages.

In some embodiments, the P-units 1130, 1115 include microcontrollers or processors for executing firmware 1235, 1236, respectively, to perform the power management operations described herein. For example, supervisor firmware (FW) 1235 executed by supervisor p-unit 1130 specifies operations such as transmission of messages sent to TX mailbox 1130, and over the private fabric 1247 to the RX mailbox 1217 of p-unit 1115. Here, the “mailbox” may refer to a specified register or memory location, or a driver executed in kernel space. Upon receiving the message, RX mailbox 1117 may save the relevant portions of the message to a memory 1218 (e.g., a local memory or a region in system memory), the contents of which are accessible by P-unit 1115 executing its copy of the FW 1236 (which may be the same as or different from the FW 1235 executed by the supervisor P-unit 1130).

In response to receiving the message, the P-unit 1115 executing the firmware 1236 confirms reception of the message by sending an Ack message to supervisor 1130 via TX mailbox 1216. The Ack message is communicated to RX mailbox 1231 via fabric 1247 and may be stored in memory 1232 (e.g., a local memory or a region in system memory). The supervisor P-unit 1130 (executing FW 1235) accesses memory 1232 to read and evaluate pending messages to determine the next course of action.

In various embodiments, supervisor p-unit 1130 is accessible by other system components such as a global agent 1255 (e.g., a platform supervisor agent such as a BMC) via public fabric 1246. In some embodiments, public fabric 1246 and private fabric 1247 are the same fabric. In some embodiments, the supervisor p-unit 1130 is also accessible by software drivers 1250 (e.g., operable within the OS or other supervisory FW/SW 1070) via a primary fabric 1245 and/or application programming interface (API) 1240. In some embodiments, a single fabric is used instead of the three separate fabrics 1245-1247 shown in FIG. 12.

### Resolving Core Management Requests

In the architectures described herein, hints may be generated by a variety of system entities. For example, overclocking and other system software entities may attempt to force parking of certain cores. In addition, workload type (WLT) hints (e.g., indicating specific workload types such as bursty, sustain, battery life, idle) can result in consolidation of performance cores or energy-efficient cores. In disaggregated architectures, for certain energy-efficient workloads, it may be preferable to shut down the compute dies 1120-1121, 1110-1111, and run out of one or more of the E-cores 1112-1113 of the SoC die 1010 (“SoC die biasing”), which may be accomplished with a parking/consolidation hint to the OS 1070. However, there are other instances where SoC die biasing is not the correct choice for improved power/performance (PnP).

In current implementations, as the system becomes constrained, all cores may be forced to run below the current power state (Pe) limit. In these scenarios it may be preferable to reduce the number of cores and run at a frequency which is more efficient and gradually unpark the cores as the system becomes able to run all cores at an efficient frequency. Some embodiments of the invention use below Pe consolidation (BPC) to contain the number of cores and bring the per-core frequency above a specified limit (e.g., when the system is frequency-limited). When the system is close to a survivability point, even after processor actions are taken to reduce power, the cores may be gradually brought down one after the other via core parking hints. The power is monitored periodically until the system returns to a stable power limit. There may also be gaming or other platform/OEM driver-aware implementations that require the platform to be less noisy, cooler, or higher performing. In these cases the platform software can request to moderate the core parking actions that are taken via WLT to achieve the desired end state from a platform standpoint.

All of the above features rely on target core parking and consolidation. Given the large number of potential variables and hints/requests, it would be beneficial to resolve these hints into a single unified hint to be provided to the schedule, while architecturally meeting the requirements of different dynamic parking scenarios that all coexist in the processor at any point in time. It would also be beneficial to determine the individual cores to be parked based on the scenario at hand and in accordance with the architectural intent and in view of an optimal PnP.

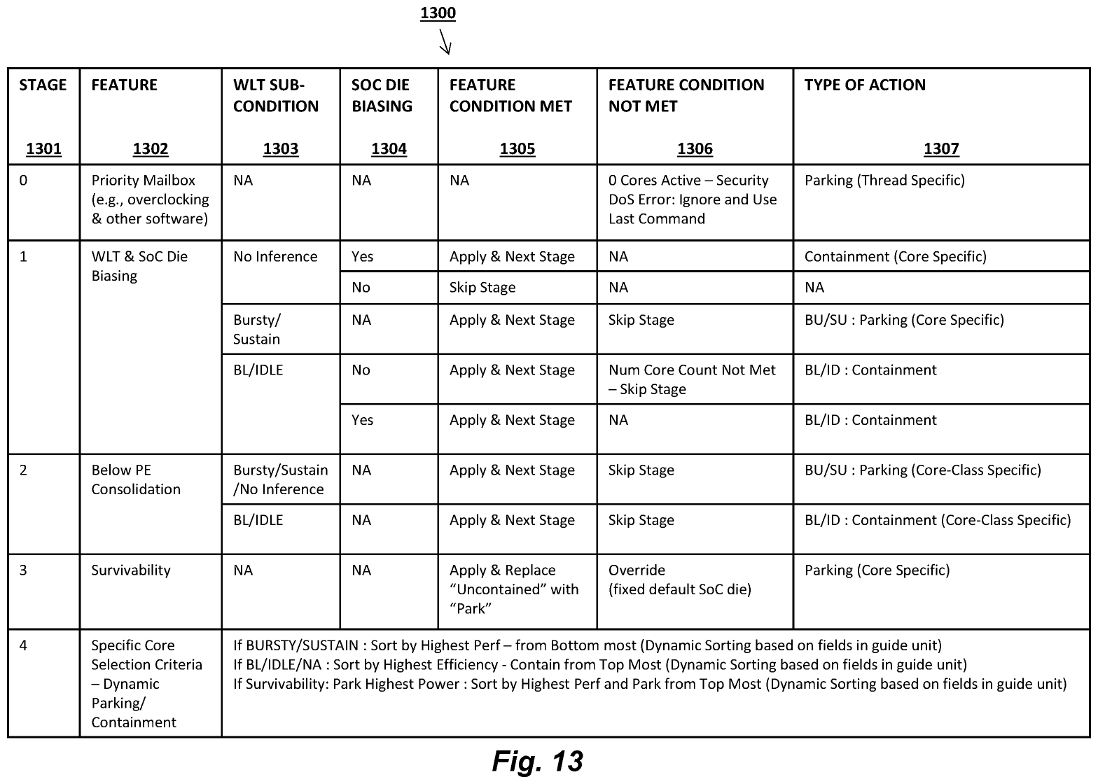

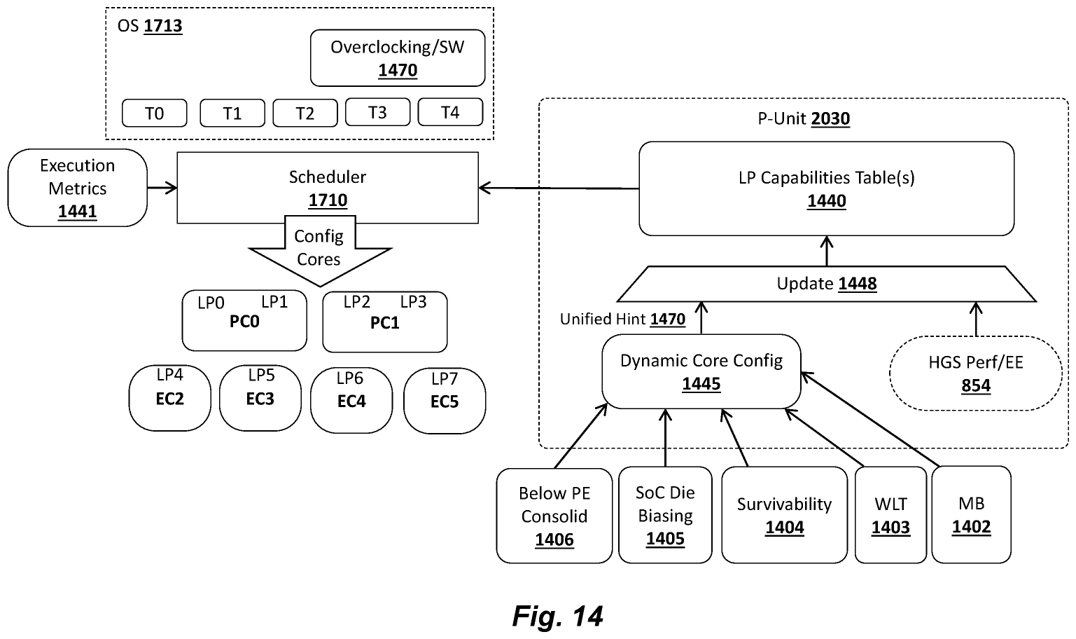

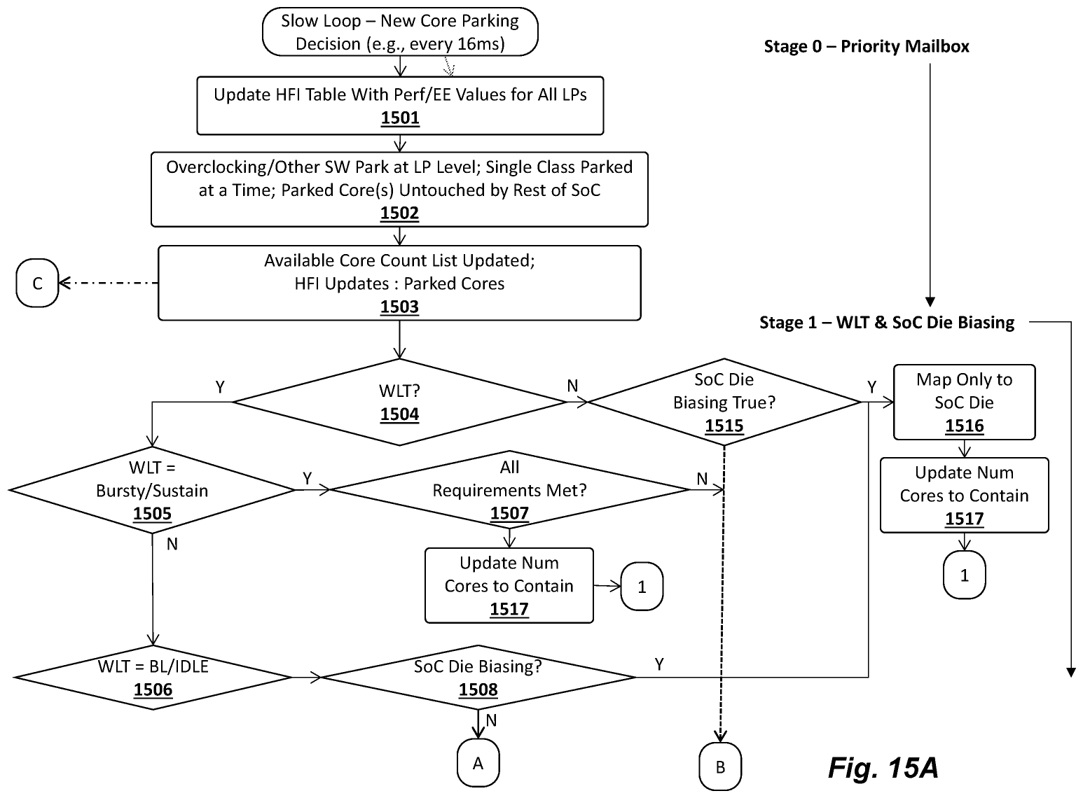

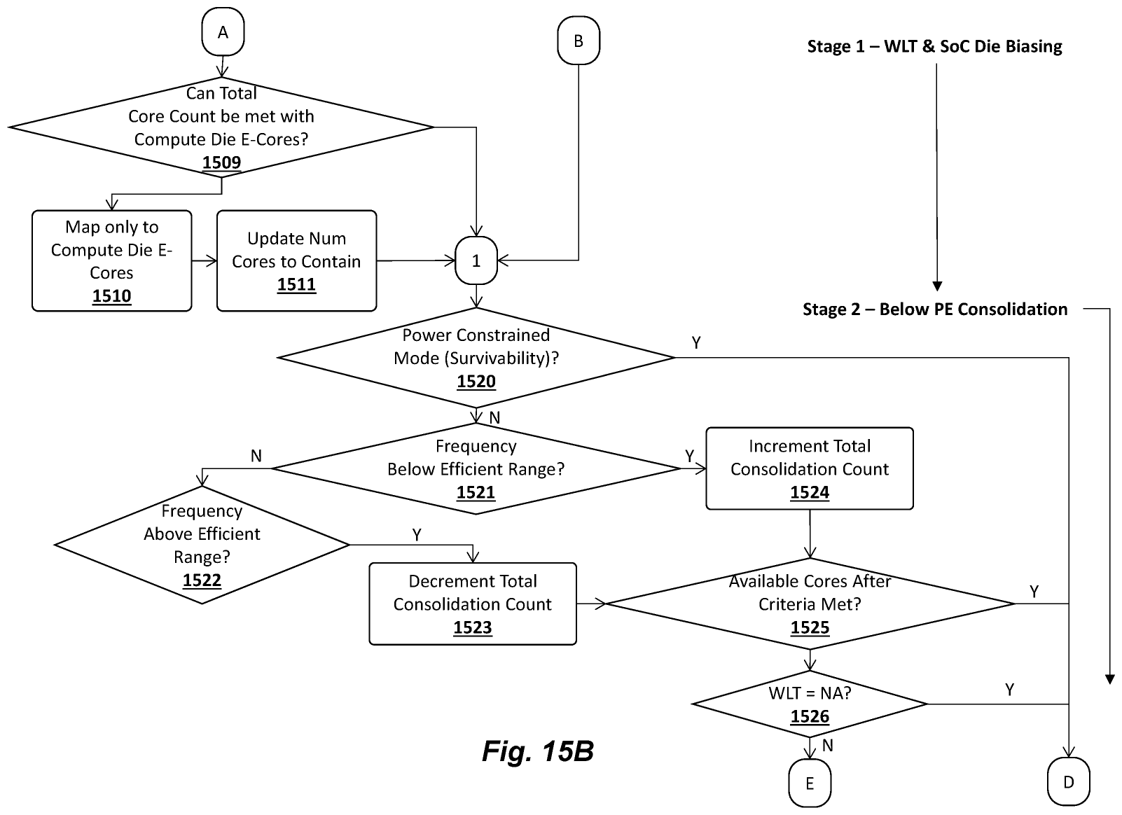

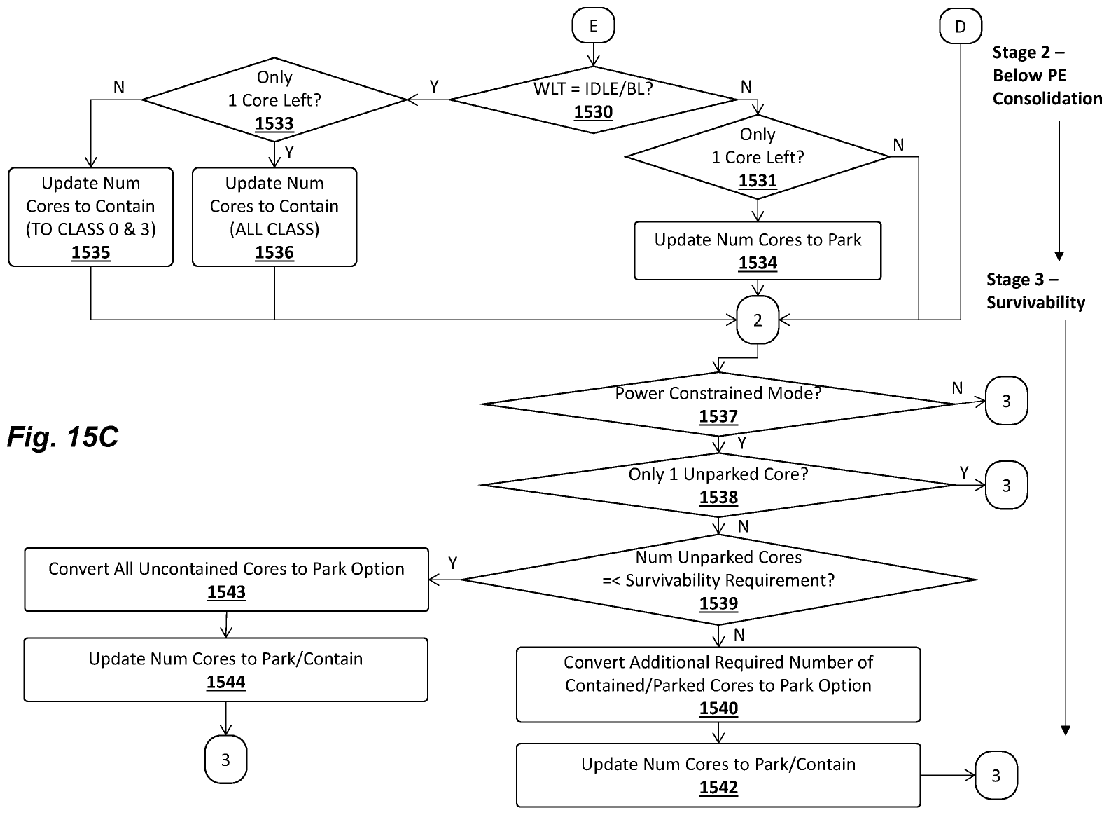

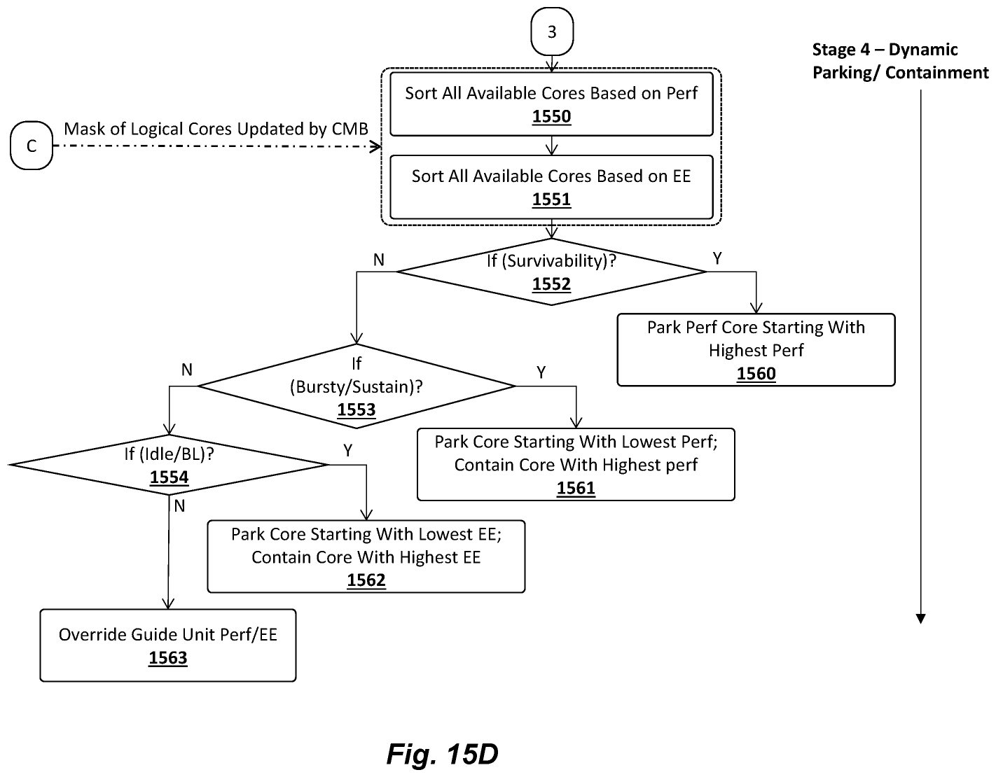

The table 1300 in FIG. 13 lists the variables used to determine the specific cores to be parked/consolidated in accordance with some embodiments of the invention. The rows are ordered in stages 0-4 (in column 1301) corresponding to the stages in the detailed flowchart in FIG. 15A-D. Table 1300 includes columns indicating the name of the associated feature 1302, the WLT sub-condition (if applicable) 1303, whether SoC die biasing is applicable and used 1304, operation when the feature condition is met 1305 and when not met 1306, and the type of action performed on the cores 1307.

In this example, as indicated in the “Stage 0” row, a priority mailbox is provided for overclocking and other software (e.g., gaming apps, . . . etc) to submit parking requests which are assigned a high priority, thereby creating a boundary condition for further optimization. For example, the priority mailbox may be used to “park” or allocate a specific core or set of cores to a specific thread or group of threads (as indicated in column 1307). In some implementations, the specific cores requested via this mailbox are always be honored. Additional checks are added to avoid Security DoS, as indicated in column 1306.

The “Stage 1” row indicates workload type (WLT) and SoC die biasing requests in column 1302. In these embodiments, the biasing to use the SoC die is qualified with the specified WLT. If the WLT indicates “Bursty” or “Sustain” then work is not moved to the E-cores on the SoC die, as indicated in column 1304, whereas workload types associated with low workload requirements (e.g., BL/IDLE sub-conditions) are aligned towards moving work to the SoC die (which is capable of running independently at the lowest power states). However, in circumstances where the E-cores of the SoC Die would not be the most efficient cores (e.g., based on a dynamic analysis such as the current supply voltage of the SoC die), then idle/battery life (BL) work is consolidated to an equivalent set of E-cores cores on a compute die.

In general, the WLT indication may be used to determine whether to perform core parking or consolidation. For sustain/bursty workloads, core parking may be used (Perf=EE=0) as this allows the OS to restrict scheduling to P-cores. For battery life/idle WLTs, core consolidation may be used (EE=255) allowing the OS to expand to other cores as the utilization increases (e.g., as measured in workload queues).

In some embodiments, exceptions to the above are specified in view of survivability scenarios (described below).

Some implementations attempt to skip below the PE consolidation stage (reducing threads to improve the frequency floor) when a survivability trigger is reached (e.g., the electrical or thermal metrics reach a threshold). This will avoid duplication as both survivability and PE consolidation attempt to reduce the number of active cores to reduce power. PE consolidation does so to improve performance. While the high level operations are the same, at a lower level the core selection techniques are different (as described further below).

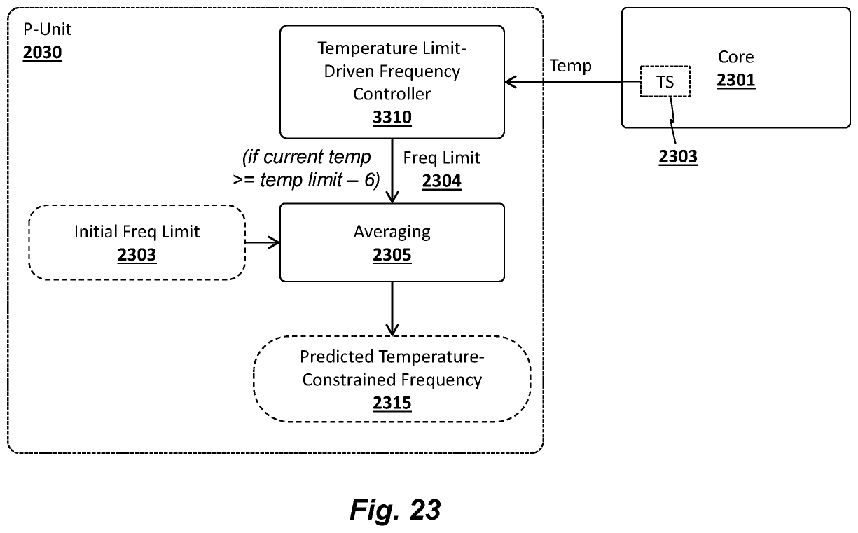

In the case of survivability, a parking hint may be generated regardless of whether WLT and/or other stages prior recommended core consolidation. This is required because for survivability, the OS should have the ability to restrict to a limited number of active cores. In some embodiments, survivability is incremental—gradually reducing the number of active cores. In one embodiment, the performance/EE projection is sorted and used to choose individual cores to park or consolidate. An example of the performance and EE projection data is shown in the logical processor capabilities table 1440 described below with respect to FIG. 23.

In one embodiment, the following approach is taken. First, for survivability, the intent is to save power. As such, the cores are sorted starting with the highest performance and the top of the sorted list is used for parking.

With respect to workload type (WLT), for battery life/idle workload types, or no inference, the intent is to use the E-cores. As such, the cores are sorted starting with the highest efficiency values. The cores to contain/consolidate are then selected from the top of the sorted list.

With respect to a WLT of bursty/sustain, the intent is to use the highest performing cores. Consequently, the cores are sorted starting by performance with the highest performance at the top of the sorted list. Cores are then selected for parking from the bottom of the sorted list.

FIG. 23 illustrates one embodiment of a power management unit 2030 including dynamic core configuration logic 1445 for implementing the techniques described herein to resolve a plurality of parking/or and consolidation requests/hints 2302-2306. As mentioned, overclocking or other software 2370 may submit core parking hints to a mailbox 2302 to park or allocate a specific core or set of cores to a specific thread or set of threads (e.g., reserving specific core(s) for specific thread(s)). Other illustrated hints/requests include those related to below PE consolidation 2306, SoC die biasing 2305, survivability 2304, and workload type (WLT) parking 2303, various examples of which are provided herein.

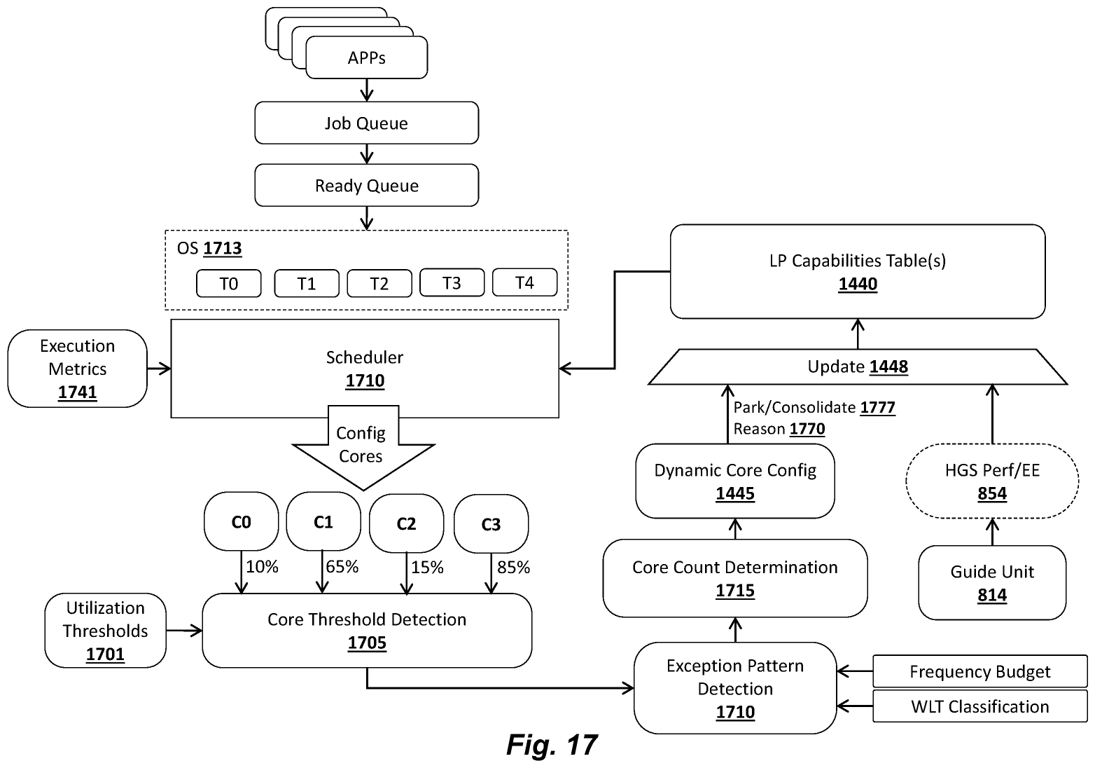

In one embodiment, the dynamic core configuration logic 1445 resolves this combination of hints 2302-2306 into a unified core parking and/or core consolidation hint 2370. In addition, the hardware guide unit 814 (sometimes referred to as the hardware guide scheduler, HGS, or HGS+) continues to generate EE/Perf updates 1754 as previously described with respect to FIG. 17. In one implementation, the HGS/HGS+functionality is encoded in the firmware 1235 executed by the SoC tile P-unit 2030.

In one embodiment, update logic 2348 updates the logical processor capabilities table 1440 based on the unified hint 2370 or the Perf/EE updates 1754. In operation, the Perf/EE HGS hints 1754 may be generated and populated locally. The dynamic core configuration logic 1445 consolidates and resolves the various features 2302-2306 attempting to independently override the HGS Hints 1754. Once the resolution is complete, the unified parking/consolidation hint 2370 overrides the HGS updates 1754 and the table update logic 2348 updates the logical processor capabilities table(s) 1440 (sometimes referred to as the hardware feedback interface or HFI table) in accordance with the unified hint 2370.

TABLE C
EXAMPLE PROCESSOR:

| 1 Big Core, 8 Compute Die | | Slider Not Enabled Config | | |
|---|---|---|---|---|
| E-cores, 2 SoC Die E-Cores | SoC Die | Big | Compute | SoC |
| WLT | Biased | Core | E-Core | E-Core |
| Bursty (PARK) | NA | 4 | 0 | 0 |
| Sustain (PARK) | NA | 4 | 8 | 2 |
| Idle (CONTAIN) | Y | 0 | 0 | 2 |
| Battery Life (CONTAIN) | Y | 0 | 0 | 2 |
| Battery Life/Idle (CONTAIN) | N | 0 | 2 | 0 |
| SoC Die E-Core Disable | | | | |

Table C provides an example of a default core parking/containment for a particular processor having 1 Big Core, 8 Compute Die E-cores, and 2 SoC Die E-cores. In this implementation, for bursty WLTs, only Big cores are enabled. in the case of battery life (BL), either 2 SoC die E-Cores or two compute die E-cores are active based on SoC die biasing. For a sustain WLT, all cores are active and for an idle WLT, two SoC die E-cores are active.

Some embodiments described herein have a disaggregated processor architecture with DLVR support as well as both compute die E-cores and SoC die E-cores, which are more efficient at certain frequencies and system states. As such, SoC die biasing is used in some embodiments in which hints consolidate operations into the SoC die E-Cores, allowing the compute die cores to be powered down and conserving power.

FIGS. 15A-D illustrates a method in accordance with various embodiments of the invention described herein. This method and portions thereof may be performed on the different processor and system architectures described herein, but is not limited to any specific processor architecture.

A new core parking decision is made in a slow (e.g., 16 ms) loop comprising the illustrated operation sequence. Starting at stage 0 (priority mailbox), at 1501 the HFI table is updated with the Perf/EE values for all LPs or a subset thereof (e.g., as performed by the guide unit). At 1502, overclocking or other software use a mailbox to park cores at the LP level, parking a single class of LPs at a time. These parked cores are associated with specific threads and are untouched by the rest of the system. At 1503, the available core count list is updated to reflect the loss of the cores parked by the overclocking or other software.

Within stage 1 (WLT and SoC die biasing), if WLT data is not available (e.g., via a WLT hint), determined at 1504, then at 1515 a determination is made as to whether SoC die biasing is true. If so, then the mapping is performed to cores of the SoC die at 1516 and the number of cores is updated accordingly at 1517 (e.g., to the set of E-cores in the SoC die). If not, then the process jumps to the PE consolidation stage (stage 2) at 1520 (described below).

If WLT data is available, then if the WLT is for a bursty/sustain workload, determined at 1505, the number of cores to contain is updated at 1517, assuming all requirements are met at 1507. If WLT is for battery life/idle workloads, determined at 1506, then if SoC die biasing is implemented, determined at 1508, the core mapping is performed only to the SoC die at 1516.

If SoC die biasing is not implemented at 1508, then at 1509 (FIG. 15B), if the total core count can be met with compute die E-Cores, the mapping is performed only to the compute die E-cores at 1510 and the num cores to contain is updated at 1511.

At the PE consolidation stage (stage 2), a determination is made at 1520 as to whether the processor/system is in a power constrained mode (e.g., a survivability mode). If so, the process jumps to the survivability stage (stage 3) in FIG. 15C. If not, then at 1521, if the current frequency is below an efficient frequency range, then at 1524, the total consolidation core count is incremented. If the current frequency is not below an efficient frequency range, then at 1522, a determination is made as to whether the frequency is above the efficient range (potentially in combination with an offset value). If so, then at 1523, the total consolidation core count is decremented.

At 1525, a determination is made as to whether there are available cores after the mapping criteria have been met. If so, then the process jumps to the survivability stage (stage 3) in FIG. 15C. If not, then a determination is made at 1526 as to whether workload type data is available. If so, then the process jumps to the survivability stage in FIG. 15C. If not, then at 1530 in FIG. 15C, a determination is made as to whether the workload type is idle or battery life. If not, and if only 1 core is left, determined at 1531, then the number of cores to park is updated at 1534. If so, the process jumps to the survivability stage at 1537. If WLT is idle/BL at 1530, then at 1533 a determination is made as to whether only 1 core is left. If so, then at 1536 the number of cores is updated in accordance with the contain operation for all classes. If not, then at 1535, the number of cores is updated in accordance with the contain operation for classes 0 and 3.

If the processor is in a power constrained mode, determined at 1537 within the survivability stage (stage 3), then at 1538 a determination is made as to whether there is only 1 unparked core. If not, then if the number of unparked cores is less than or equal to a survivability threshold, determined at 1539, all uncontained cores are parked at 1543. At 1544, the number of cores are updated in accordance with the park/contain operations. At 1539, if the number of unparked cores is not less than or equal to the survivability requirement, then at 1540 an additional required number of contained/parked cores are converted to park and at 1543 the number of contained/parked cores is updated.

Within the dynamic parking/containment stage (stage 4) in FIG. 15D, all available cores are sorted by perf values at 1550 and sorted based on EE values at 1551. If survivability is operational, determined at 1552, then the cores are parked starting with the highest performance cores (e.g., in accordance with the sorted list from 1550). If survivability is not operational then at 1553 a determination is made as to whether WLT is bursty/sustain. If so, then cores are parked starting with the lowest performance and the core(s) with the highest performance are contained at 1561. If the WLT is idle/battery life (BL), determined at 1554, then at 1563 the perf/EE values generated from the guide unit are overridden as described herein (e.g., by the dynamic core configuration logic 1445 previously described).

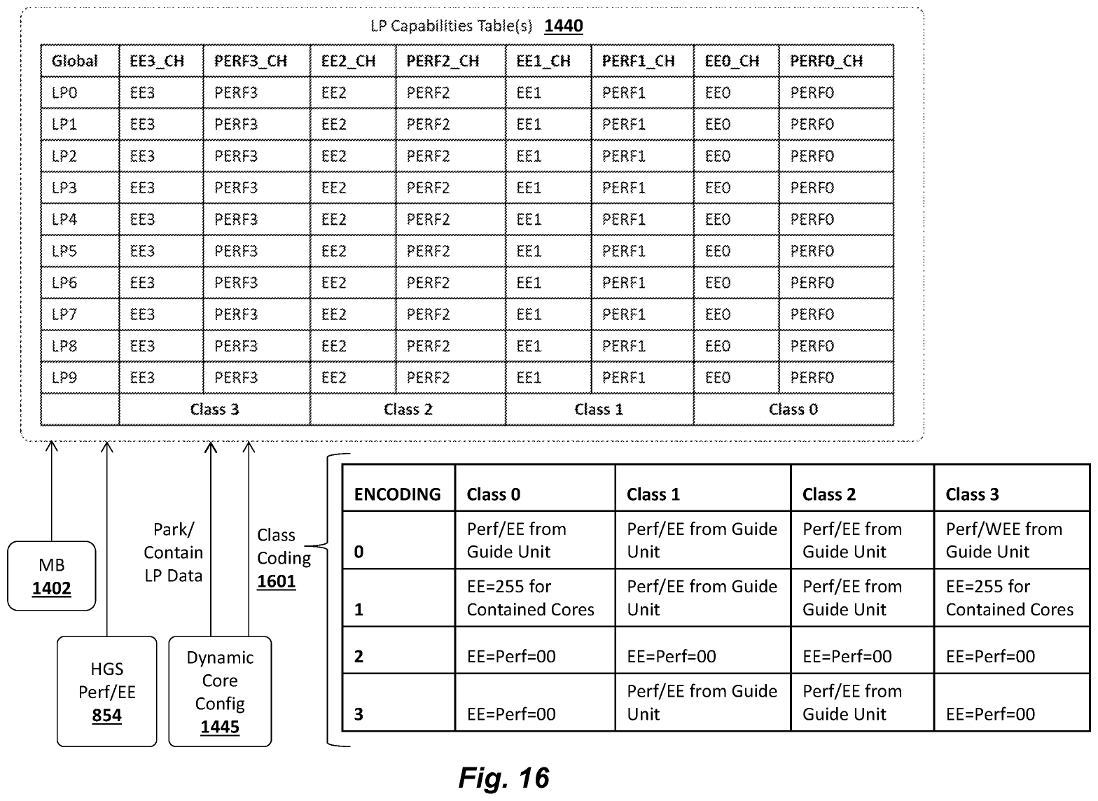

FIG. 16 illustrates an example set of EE/Perf data in a logical processor capabilities tables 1440 and different sets of class coding data 1601 indicating different combinations of Perf/EE values for different classes associated with LPs. In one implementation, the guide unit 814 determines the per-LP Perf/EE values 854 to be populated to the capabilities tables 1440 which is updated accordingly.

These Perf/EE values 854 may be overwritten by updates generated from the priority mailbox 1402 (e.g., originating from overclocking software or other forms of software operating at the appropriate privilege level), which may indicate thread-specific parking of one or more cores. In one embodiment, the dynamic core configuration logic 1445 determines the exact set of cores to be parked and/or contained based on the various inputs (e.g., the hints described above) and creates a compressed bitmap of overrides in accordance with the class coding 1601 (i.e., indicating the specific LP #and class to be updated based on the encoding).

The various techniques described above may be implemented (a) in P-code executed by one or more of the power management units (P-units), such as P-unit 2030; (b) using a combination of P-code and driver/kernel code (executed on a core); (c) in hardware; or (d) a combination of P-code, driver/kernel code, and hardware.

### Apparatus and Method for Utilization-Based Core Parking

With a hybrid architecture (e.g., with heterogeneous cores/processing engines), scheduling is critical for compute performance. Some existing architectures deliver reasonable performance on highly-threaded, high-load applications. In certain client platforms, however, various types of workloads (e.g., gaming and productivity) under-utilize the cores or go through phases of fully utilized to under-utilization, when improved power and performance (PnP) can be achieved by reducing to a particular number of cores.

Current implementations are split between two independent controls: Operating System (OS) scheduling and processor hardware P-state control (HWP). Scheduling by the OS is done based on certain aspects of the application rather than focusing on the utilization of the threads/cores. Hardware P-state control adjusts the frequency of the cores based on utilization. As a result, scheduling on fewer cores drives the frequency up and vice versa. The OS is typically aware of the total compute capacity demand, the priority, and the class of service of applications. The processor has runtime execution information such as ISA performance, memory dependencies, core topology, and voltage-frequency curves.

Scaling the number of cores by the processor based on utilization, while accounting for the runtime and processor characteristics would yield improved PnP, but cannot be done without close coordination with the OS scheduler, while factoring in current system scenarios, and dynamically creating exceptions as needed.

In some embodiments described above, the guide unit (sometimes referred to as the hardware guide scheduler (HGS/HGS+) provides hints to the OS scheduler using one or more hardware feedback interface (HFI) tables which provide Perf/EE capability on a per class/per core level (e.g., the LP capabilities tables 1440 in FIG. 16) every 16 ms. These classifications may be performed by the OS at a per-application level, averaging multiple seconds. The Perf/EE hints help the OS to schedule workloads to the most capable cores.

Hardware P state controls in the processor collects finer grained data on per-core utilization and scalability at 1 ms granularity, and uses this data when scaling the frequency of the cores (e.g., within the context of HWP/productive autonomous algorithms). Some implementations have used machine learning to characterize the WLT, which is then used for P-state selection.

Some newer processors implement hardware-based core parking, as described above. Different system scenarios and workload types (WLTs) are used to determine what class of cores are to be hinted to the OS as the best to use at any moment (e.g., every 16 ms). Additionally, when the overall core frequency floor drops below a threshold, more cores are hinted to be parked gradually so that the overall frequency floor is improved, resulting in better performance.

There are a variety of problems with these architectures. For example, the guide unit does not take into account utilization and scalability while hinting to the OS, nor does it use WLT as a metric to create exceptions for when (and when not) to disturb multithreading applications. The hardware P state implementations focus on maintaining target utilization by adjusting frequency but does not provide hints to the OS to consolidate cores considering utilization levels. Implementations that provide hints to the OS on core types (BigCore, Atom) in view of WLT, do not consider core utilization metrics in combination with WLT to arrive at optimal and gradual core consolidation. Finally, the OS scheduler is conservative and does not evaluate core configuration holistically, prioritizing scalable threads over non-scalable threads.

To address these limitations, embodiments of the invention determine if the utilization and scalability of threads warrants a change in the number of active cores. The consolidation of cores is dynamic, based on utilization and additional exceptions based on WLT hints. In addition, these embodiments inform the OS (e.g., using HFI header bits) that the hint decision is based on utilization and WLT data at the SoC level. The OS can then determine whether or not to rely on the hints to modify scheduling. For example, the OS may choose not to honor if there are additional application-level hints that indicate that a multi-threading with low utilization is desired.

The following are examples of exceptions implemented by one or more embodiments of the invention.

The bowser benchmark “WebXprt” has short durations where it needs multiple under-utilizing threads to be available. It has been observed that during these short durations, the workloads tend to be Bursty. As such, WLT Bursty can be used as additional qualification (or exception) for low utilization for short durations not hinting that a core optimization is needed.

Gaming applications may need multiple threads which are not fully utilized for an extended period of time. These specific gaming applications would indicate a sustain WLT scenario, which can be used as an exception not to reduce the core count.

There are also gaming applications which are highly dynamic and with utilization levels that gradually increase. If the OS is permitted to schedule, it might consume the maximum number of cores available and spread the utilization across the cores. For these cases, embodiments of the invention monitor the utilization level over 16 ms average intervals and the utilization data used to gradually hint at the number of cores to increase or decrease. The OS scheduler is expected to follow the hint and gradually change the active core count, thereby creating more turbo headroom than when work is always spread across cores, thereby improving performance.

FIG. 17 illustrates additional details associated with these embodiments of the invention. As in prior embodiments, HGS Perf/EE hints 854 are updated in the logical processor capabilities tables 1440 and provided to the scheduler 810 on a per-class/per-core level every 16 ms. In one implementation, the class levels include Class 0 for mainstream workloads, Class 1 for floating-point and memory-bound workloads, Class 2 for machine learning workloads, and Class 3 for non-scalable workloads. It should be noted, however, that these specific classes are described merely for the purpose of explanation. The underlying principles of the invention are not limited to this specific set of classes.

In one embodiment, the OS performs classifications of active workloads on the per-application level, averaging multiple seconds. These classifications are not directly tied to the dynamic hints generated by the dynamic core configuration logic 1445 or other processor entities.

As mentioned, the guide unit 814 determines per core capabilities (Perf/EE) at a class level granularity, as reflected in the Perf/EE data 854, using various factors such as the voltage/frequency curve, thermal data, core types, and the current operating point. These per core capabilities are exposed as hints to the OS at 16 ms intervals via the LP capabilities table(s) 1440 (aka, HFI table).

As previously described, there are several features in the SoC that can generate hints to reduce core count. In the illustrated embodiment, the dynamic core configuration logic 1445 resolves these separate hints to arrive at the final set of cores to be contained and/or parked. In the illustrated embodiment, the dynamic core configuration logic 1445 communicates both the park/consolidation hint 1777 and the underlying reason(s) 1770 for the parking/consolidation hint. The parking/consolidation hints 1777 may override the original HGS perf/EE hints 1754. In some embodiments, hints to park or disable cores can be communicated to the OS by populating Perf and EE values to be “0x00” in the LP capabilities table(s) 1440.

In one embodiment, the utilization and scalability associated with the cores (shown as C0-C3 for simplicity) is monitored at a significantly higher granularity than the speed at which hints are provided to the OS (e.g., 1 ms granularity compared to 16 ms for hints). In particular, core threshold detection logic 1705 detects when specified utilization thresholds 1701 are crossed within each 16 ms interval. In response, exception pattern detection logic 1710 detects one or more predefined exception patterns (e.g., multi-threaded, low utilization, bursty, etc) in view of variables such as the frequency budget and WLT classifications.

In one implementation, core count determination logic 1715 applies specified thresholds to determine if the current core count is in a desired range for the utilization and system scenario (e.g., such as bursty, battery life, sustain, and idle). If the core count is not within the desired range, the core count determination logic 1715 communicates recommended updates to the dynamic core configuration logic 1445, which gradually provides hints based on the appropriate utilization level, along with the reasons 1770 associated with the hints. Operation may be scaled up or down at 16 ms intervals while keeping track of system scenarios and utilization targets.

With the reasons 1770 provided along with the hints, the scheduler 1710 learns when the parking/consolidation hint is done for PnP. As mentioned, the scheduler 1710 may ignore hints when the running application needs multithreaded operation, even if it is at low utilization. This added communication to the scheduler 1710 ensures that PnP will not be impacted for specific types of applications that behave differently. The exception will be a combination of utilization levels, workload types, and system frequency.

In one embodiment, a new “reason” bit is added to indicate that the parking hint is for PnP reasons. The scheduler 1710 may then use this parking reason, for example, to ignore the hints for certain types of applications (e.g., such as the multithreaded applications required to run at low utilization levels).

### Power Limited Frequency of Soc Components

When multiple compute IPs (processor cores, graphics units, AI units, etc.) are executing in a power-constrained system, the power subsystem (e.g., P-units 1030-1033) needs to allocate power budget to these IPs in a manner that delivers customer-desired performance. When reallocating power budget, it must be recognized that the relative priority of each type of compute may be different (and may change at run time), and the power vs. frequency and frequency vs. performance relationship may be different for each of the compute IPs.

In some existing implementations, the performance balancing challenge is limited to a single type of processor core and a graphics accelerator. When executing work on both types of compute IPs simultaneously, the graphics driver has a knob used to force a relationship between the processor core and graphics accelerator frequency. This frequency relationship drives the power allocation and is adjusted at runtime according to the performance needs of the graphics workload. For example, the graphics accelerator may determine that for a particular graphics application running on a particular processor, power constrained performance is optimized when the compute core runs at twice the frequency of the graphics accelerator. To enforce this frequency relationship while maximizing performance, the processor allocates power budget as needed to maintain that frequency relationship.

Embodiments of the invention include techniques for setting a normalized performance relationship between each type of compute IP in a processor (e.g., an SoC or multi-chip module). By way of example, and not limitations, the compute IPs can include CPU cores operable at different performance levels (e.g., P-cores and E-cores), graphics cores, general purpose GPU cores, DSP cores, and accelerator cores/units (e.g., for machine learning, data compression, data parallel processing, etc). These embodiments allocate a power budget to each of the compute IPs such that the power-constrained frequency for each results in the delivered performance meeting the programmed performance relationships, while also complying with the available power budget.

In one embodiment, power balancer firmware/software specifies a sequence of operations to be executed periodically (e.g., every 1 ms) to rebalance frequencies based on resource consumption over the previous cycle. The power balancer firmware/software may be executed by one or more of the P-units 1030-1033 described above or one or more processor cores. Alternatively, the power balancer operations may be implemented in hardware (e.g., as a state machine) or using a combination of hardware and software/firmware.

In some implementations, a closed loop Proportional-Integral-Differential (PID) algorithm is executed to determine the available power budget(s) in use during the next iteration. There may be multiple different power constraints for a given product, and hence there may be multiple independent PID algorithms running in parallel. The output of these PID algorithms, “R” are unitless numbers between 0-255 that represents the amount by which the SOC must reduce power consumption over the next iteration in order to stabilize the power budget. A value of 255 indicates that the available budget is unlimited, while progressively lower values represent a need to reduce the power consumption during the next time window.

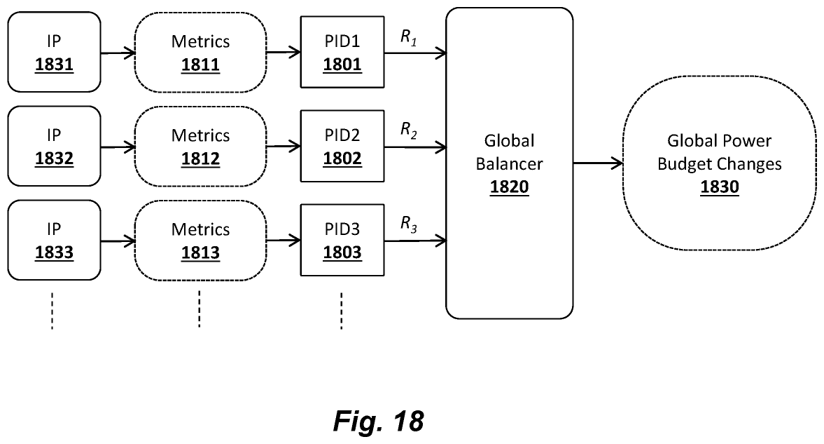

FIG. 18 illustrates an embodiment in which each of a plurality of IP blocks 1831-1833 provides power consumption/utilization metrics 1811-1813 for the current iteration to a plurality PID modules 1801-1803 operating in parallel. Each PID module 1801-1803 implements its sequence of proportional-integral-differential operations using the input metrics 1811-1813, respectively, to generate a set of corresponding outputs RI-R3.

Each PID module 1801-1803 in the system tracks its “R” separately, and outputs an independent constraint on power consumption. In one embodiment, a global balancer 1820 then selects the most constrained output of each of these PID modules 1801-1803 to determine the required power reduction for the corresponding IP blocks 1831-1833. In this context, an IP block may be a single compute IP (e.g., a CPU core) or a group of IPs that are related in some manner such as IPs that are physically contained on a common piece of silicon (e.g., all E-cores in a cluster, all CPU cores in the processor, all graphics cores, etc).

To maximize the user perceived performance of the system, this available power budget should be allocated to the IP blocks covered by the power balancing operations in a manner that maximizes system throughput. This requires knowing the relative “priority” of each of the IP blocks 1831-1833—which is configurable in at least some embodiments.

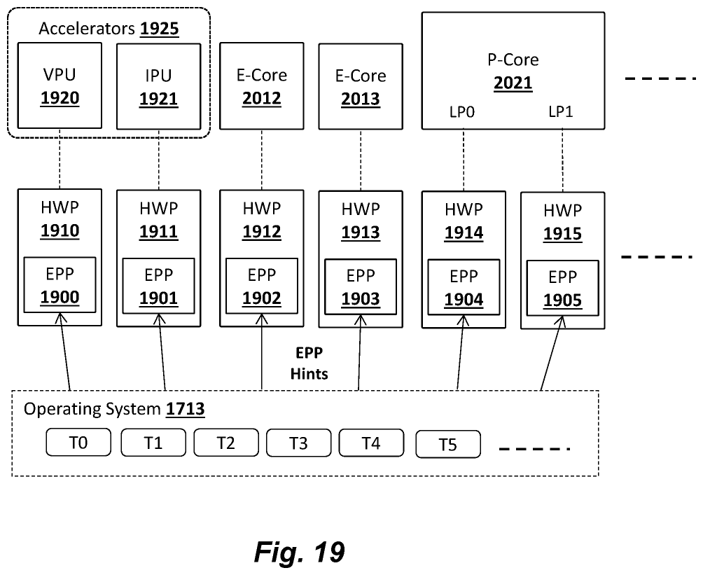

In some implementations, the relative priority for each of the logical processors/cores is inferred from energy performance preference (EPP) hints provided by the operating system for each task running in the system. Referring to FIG. 19, in these embodiments, an energy performance preference “EPP” value 1900-1905 is set by the OS 1713 within HWP registers 1910-1915 of the hardware P-state architecture (HWP). Each HWP register 1910-1915 is associated with a particular logical processor (LP). For example, HWP registers 1912-1913 are associated with LPs of E-cores 2012-2013, respectively, HWP registers 1914-1915 are associated with two respective LPs of P-core 2021, HWP register 1910 is associated with vector processing unit 1920, and HWP register 1911 is associated with infrastructure processing unit (IPU) 1921. In one embodiment, the HWP registers 1910-1915 are considered part of the power management subsystem and may be associated with one or more of the various power units described above (e.g., P-units 2030-2033). While a specific set of LPs are shown in FIG. 19 for the purpose of explanation, the underlying principles of the invention may be used with any type of LP (e.g., including LPs for CPU cores, graphics cores, and accelerator cores).

In one embodiment, the HWP registers 1910-1915 are 64-bit model specific registers (MSRs) and the EPP values 1900-1905 comprise 8-bit values stored within a specific range of bits within the MSRs (e.g., bits 31:24). In one particular implementation, the HWP registers 1910-1915 are separate instances of an IA32_HWP_REQUEST MSR, although the underlying principles of the invention are not limited to any particular register type.

In one implementation, when running a new task or set of tasks, the OS updates the corresponding EPP values (e.g., for the LPs used to execute the task(s)). The encoded EPP values 1900-1905 represent a scalar number from 0-255, with 0 indicating a preference to maximize performance for that task, and 255 indicating a preference to maximize energy efficiency. In some embodiments, the processor infers that the tasks that are biased the most toward performance are the highest priority tasks running on the LPs/cores. In some embodiments, when a particular IP block on the SoC is not assigned an EPP value (e.g., such as the graphics processor or media engine), these IP blocks are assigned a priority equal to the maximum priority of all of the other IP blocks in the system (e.g., the E-cores, P-cores, VPU, IPU).

Thus, the EPP values 1900-1905 provide a software notion of relative priority of each of the IP blocks. Embodiments of the invention use this information to allow software to adjust relative priority in order to optimize the user-perceived operating characteristics of the platform. To do this, these implementations rely on the notion of a relative priority input for the compute accelerators 1925. This relative priority indicator, sometimes referred to as “R weight”, is a 6 bit value that encodes relative priority, with lower values indicating higher priority, and higher values representing lower priority. The R weight value may be stored in the HWP registers 1910-1915 or in one or more different power management registers.

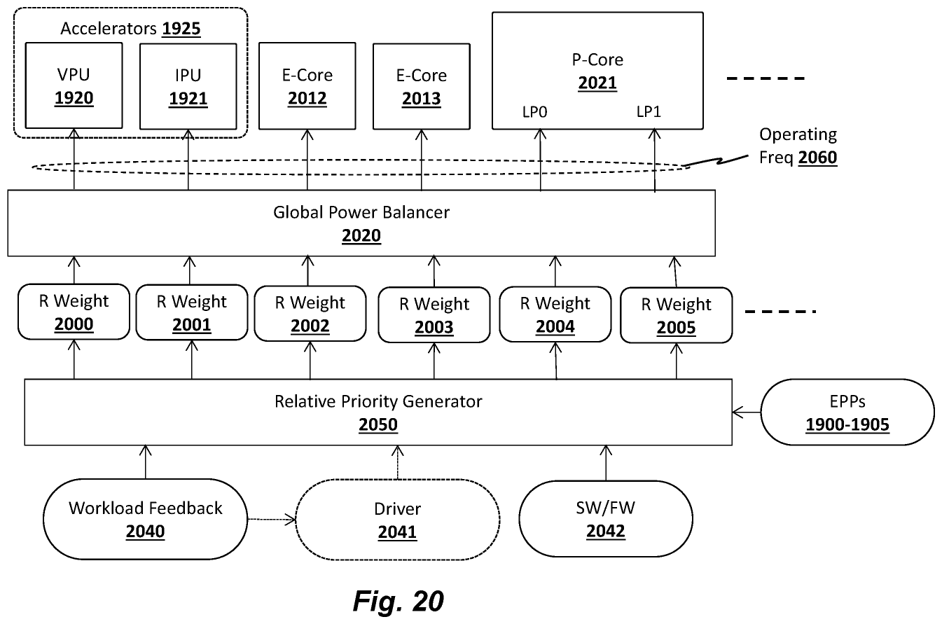

As illustrated in FIG. 20, in one embodiment, a relative priority generator 2050 generates the R weight values 2000-2005 for corresponding IP blocks 1920-1921, 2012-2013, 2021 based on the corresponding EPP values 1900-1905 and software/firmware programming 2042. The R weight values 2000-2005 may be programmed statically (e.g., during the boot process) or dynamically based on workload feedback 2040 (e.g., indicating the types of workloads being executed and/or based on the intended usage model for a given system). For example, for a computer system being sold for AI performance, the OEM may statically program the R weight value 2000 for the VPU 1920 such that it is prioritized over all other compute accelerators (e.g., assigning the VPU an R weight value of 0). The programming may be done via an API provided by the software/firmware 2042 or via other interfaces. Alternatively, or additionally, a power management driver 2041 may implement or access the relative priority generator 2050 to dynamically adjust the R weight values for different IP blocks at runtime, potentially using the workload feedback 2040 indicating the types of workloads being run (potentially in combination with input from the end user), to achieve the desired level of performance for each workload.

Once the available power budget is known, and the relative priorities 2000-2005 of each of the compute IPs has been determined, a global power balancer 2020 allocates the power budget to each of the individual IP blocks 1920-1921, 2012-2013, 2021 in the form of an allowable operating frequency 2060 (and/or voltage), such that the resulting performance is optimized based on the communicated priority information. For this purpose, note that the translation between power, frequency, and performance is likely different for each of the compute IPs, and is not linear across the operating range. In general, performance of an IP is linearly proportional to IP block's operating frequency, but power consumption scales quadratically with operating frequency. Thus, one embodiment of the global power balancer 2020 is programmed with voltage-frequency tables and other power-related data for each of the IP blocks 1920-1921, 2012-2013, 2021.

In one embodiment, such as in a disaggregated architecture, the relative priority generator 2050 and global power balancer 2020 are implemented in the supervisor P-unit 1030 in the SoC tile 1010. The resulting frequency/voltage allocations 2060 are then communicated to other P-units 1031-1033 which apply the frequency allocations to their local IP blocks (e.g., P-unit 1032 on CPU tile 1015 for controlling the local P-cores and E-cores).

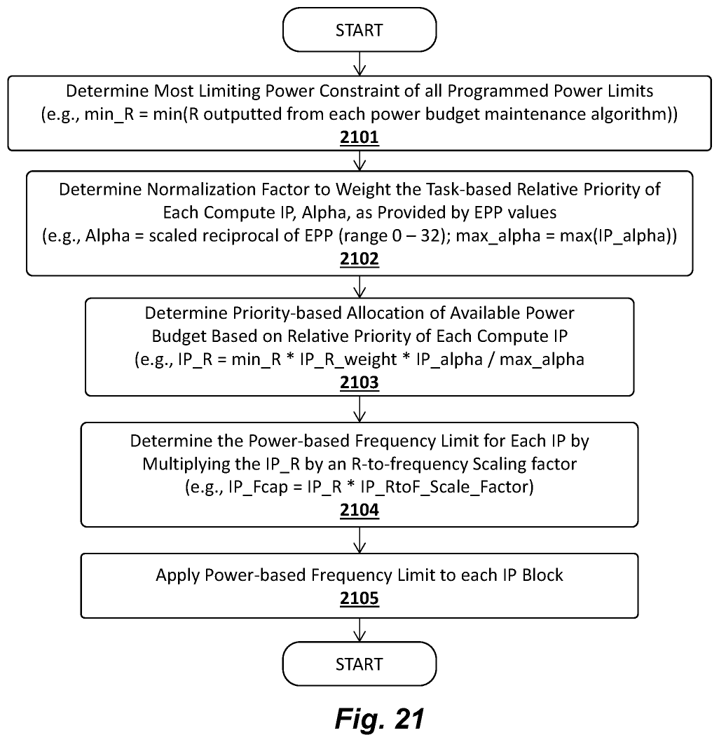

A method to determine the frequency limit for each IP block in accordance with one embodiment of the invention is illustrated in FIG. 21. The method may be implemented within the context of the various processor architectures described herein, but is not limited to any particular processor architecture.

At 2101, the most limiting power constraint of all the programmed power limits is determined. In one implementation, this is done by taking the minimum R value generated by each set of power budget maintenance operations (e.g., each PID 1801-1803).

At 2102, the normalization factor is determined for weighting the task-based relative priority, Alpha, for each IP block. As mentioned, this may be determined by the EPP values. For example, in one embodiment, Alpha is a scaled reciprocal of EPP with a range of 0 to 32 (i.e., max_alpha=max(IP_alpha)).

At 2103, the priority-based allocation of the available power budget is determined based on the relative priority of each of the compute IPs. In one embodiment, this determination comprises: IP_R=min_R*IP_R_weight*IP_alpha/max_alpha

At 2104, the power based frequency limit for each IP block is determined by multiplying the IP_R value by an R-to-frequency scaling factor which accounts for the power->frequency->performance translation for that IP block. In some embodiments, this is implemented via a lookup table for each IP: IP_Fcap=IP_R*IP_RtoF_Scale_Factor.

Once the power based frequency limit is determined for each IP block, the resulting frequency cap is applied to each IP block at 2105. Note that the actual frequency can be further reduced by other constraints or optimizations implemented by the corresponding P-unit.

In one embodiment, a closed loop feedback algorithm is used. As such, the resulting operating frequencies will determine the power consumption of each IP block over the next time window, at which point the process will be repeated (i.e., starting from 2101 in FIG. 21).

In the various implementations described herein, the thermal conditions associated with each IP block are considered when making power management decisions.

### Temperature Constrained Performance-Aware OS Scheduling in a Processor with a Hybrid Architecture

In some embodiments, the thermal conditions associated with each IP block are considered when making power management decisions. In a disaggregated architecture, each tile includes one or more temperature sensors to measure and report the temperature of IP blocks within the corresponding tile via the power management subsystem.

Embodiments of the invention include techniques for exposing temperature-constrained performance capabilities of the SoC to the operating system for use in performance-based workload scheduling. Temperature-based performance capability variations of the different types of cores exist for various reasons such as variations in manufacturing as well as the thermal characteristics of each workload. Some embodiments of the invention are configured to perform workload scheduling in view of these core/workload characteristics to make more efficient scheduling decisions in response to temperature data.

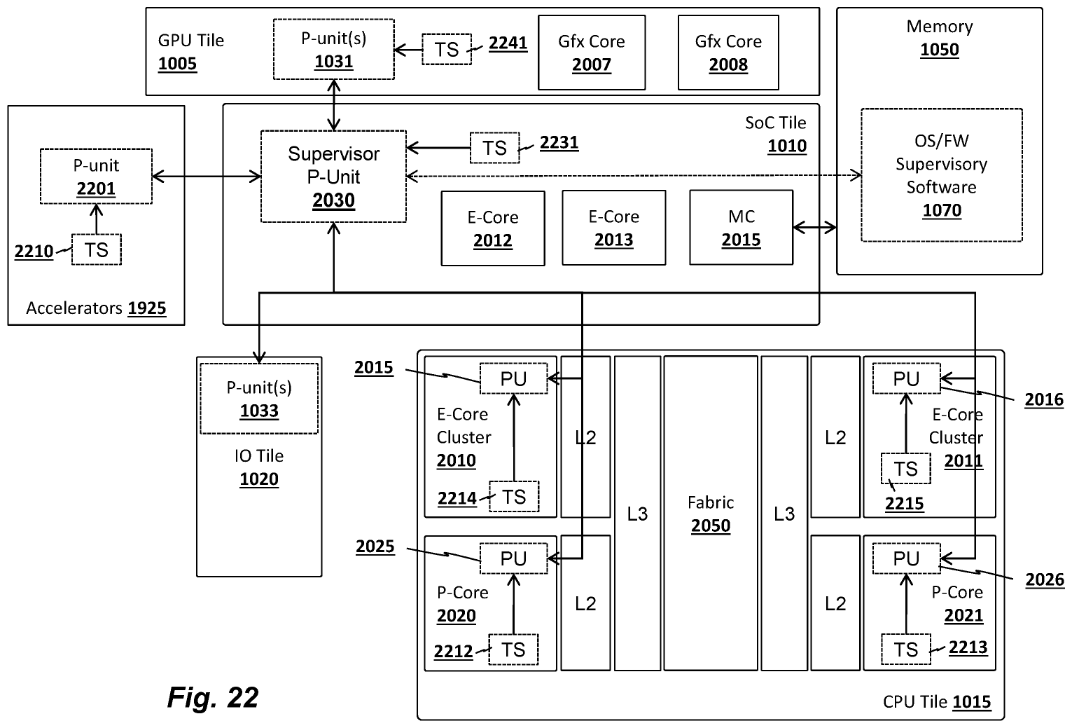

FIG. 22 illustrates an example SoC in which temperature sensors 2212-2213 associated with each P-core 2020-2021 and temperature sensors 2214-2215 associated with each E-core cluster 2010-2011, respectively, report temperature measurements to a corresponding local P-unit 2025-2026, 2015-2016. The local P-units 2025-2026, 2015-2016 may dynamically adjust local power consumption based on the temperature measurements and/or pass the temperature measurements to the supervisor P-unit 2030 which makes package-wide power management decisions based, at least in part, on the temperature measurements.

Similarly, a temperature sensor 2241 associated with GPU tile 1005 reports temperature readings to its P-unit 1031 and a temperature sensor 2251 associated with the accelerators 1925 reports its temperature readings to its P-unit 2201. Both P-units 1031, 2201 may dynamically adjust local power consumption based on these measurements and/or send the temperature measurements to the supervisor P-unit 2030 for package-wide power management decisions. In the illustrated example, a temperature sensor 2261 on the SoC tile 1010 reports temperature measurements directly to the supervisor P-unit.

In a processor with homogenous cores, temperature information can be exploited to optimize performance because cooler cores can achieve improved performance over warmer cores from the perspective of basic temperature constraints. However, for SoCs with hybrid processor cores, such as the SoC illustrated in FIG. 22, consideration of core temperatures alone to determine core selection can lead to ineffective decisions.

Embodiments of the invention consider additional thermal and performance characteristics of each core or other IP block before making a task scheduling or migration decision—instead of simply deciding based on current temperature and thermal limits. The different thermal and performance characteristics of the different core types may be a result of the fabrication process used to produce the cores, the underlying core architectures, production variability, and potentially other variables. In some embodiments described here, the type 1 cores are ULT cores and the type 2 cores are XLT cores.

As one example of core variability, cores of a first core type (“type 1” cores) are capable of providing higher achievable performance/frequency than cores of a second core type (“type 2” cores), but there are additional leakage/power costs associated with type 1 cores. Due to this additional leakage/power cost, the type 1 cores can become less performant than the type 2 cores under certain power/thermally constrained scenarios.

Embodiments of the invention consider these variables before scheduling or migrating task. In one specific implementation, while running certain workloads, a type 1 core can still achieve a higher performance (i.e., defined by a maximum frequency) than a type 2 core even after hitting its transistor junction temperature (Tjmax) limit when the type 1 core is integrated in a processor with a particular base power value (e.g., a SKU with a 45 W base power specification). However, for cores associated with a second base power value (e.g., a SKU with a 28 W base power specification), the type 1 core becomes less performing after hitting its Tjmax limit compared to a type 2 core under the same workloads. Consequently, using only core temperature without comprehending its impact on the performance of different core types could lead to inefficient scheduling actions.

As mentioned above, embodiments of the invention take into consideration the temperature constrained performance of an IP block (e.g. a core) at its temperature limit when deciding where to schedule tasks to for execution. First, the temperature constrained frequency of a core at its temperature limit is predicted. Second, the performance of the core is dynamically updated based on detected temperature changes and the core's resolved temperature constrained frequency. This information is then provided to the scheduler so that it can optimally schedule tasks.

The temperature-constrained frequency of a core is dependent on many factors ranging from transistor layer to system cooling solutions. For example, transistors with different voltage/frequency characteristics can yield different temperature-constrained performance when operating at temperature limits. Mounting the same processor/SoC to systems with different cooling solution can also result in different temperature-constrained performance. In addition, workloads with different thermal characteristics will sometimes cause the processor/SoC to have different temperature-constrained performance.

Embodiments of the invention use various methodologies to resolve temperature-constrained frequencies. For example, one embodiment simply uses a constant value defined through offline calibration. Additionally, to accommodate the variation on the platform level, some embodiments define a set of choices associated with different platform configurations and choose one based on platform input at run time. Moreover, some embodiments implement runtime learning to predict the temperature-constrained frequency of a core based on observations of the behavior of the cores at runtime.

Embodiments of the invention may employ all or a subset of the above techniques to predict the temperature-constrained frequency of a set of cores. Some specific examples below implement a runtime prediction which can be optimized for each individual system since the prediction is made based on the actual characteristics of each system at runtime.

FIG. 23 illustrates an embodiment in which a temperature limit-driven frequency controller 2310 of a power management unit (P-unit) 2030 determines a temperature-constrained frequency 2304 of a core 2301 based on measurements made by a temperature sensor 2303 associated with the core 2301. The core 2301 may be any type of IP block including, but not limited to, a graphics core, an accelerator core (e.g., a VPU or IPU core), an E-core, or a P-core.

In one embodiment, the following sequence of operations are performed to predict the temperature-constrained frequency of the core 2301. First, the P-unit 2030 monitors the temperature provided by the temperature sensor 2303 (and potentially other temperature sensors) and tracks the frequency of the core 2301 due to its temperature constraints. In FIG. 23, if the current temperature measurement indicates a temperature above a specified threshold (e.g., >=temp limit−6 in the example) then the temperature limit-driven frequency controller 2210 specifies a corresponding frequency limit 2304. In one embodiment, averaging logic 2305 dynamically generates a predicted temperature-constrained frequency 2315 based on the frequency limit 2304 and the initial frequency limit 2303 (i.e., the starting frequency limit for the current iteration). For example, the initial frequency limit 2303 may be the previously-selected frequency limit, which may have been set when the core temperature was higher or lower than the current temperature. By way of example, the initial frequency may be set when the core's temperature exceeded temperature limit −1.

In one embodiment, the averaging logic 2305 generates an exponentially-weighted moving average to predict the new temperature-constrained frequency limit 2315. For example, an exponentially-weighted moving average can be used to distinguish circumstances when the core temperature is rising from those when the temperature is dropping. Note, however, that the underlying principles of the invention are not limited to any particular averaging technique. The predicted temperature-constrained frequency limit 2315 is sometimes referred to as the predicted saturated frequency, or Fₛₐₜ.

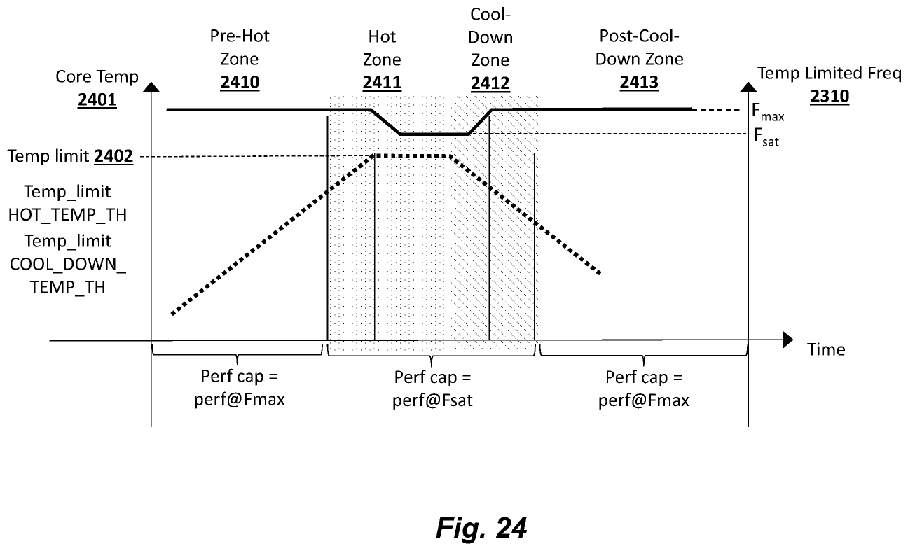

In one embodiment, the performance specifications for the core 2301 are dynamically updated based on temperature changes. Assuming that the predicted saturated frequency 2315 is resolved as described above, FIG. 24 illustrates an example of how these embodiments dynamically update the performance capability of a core based on its corresponding temperature change. In some embodiments, the HFI interface is used to notify the OS/scheduler of the updated performance capabilities. For example, the Perf values corresponding to the LPs of the core may be updated in the capabilities table 1440 as described above. It will be assumed that a core's performance is calculated as Frequency×Instruction-Per-Cycle (IPC).

The core temp 2401 in FIG. 24 is represented as the dotted line spanning a pre-hot zone 2410, a hot zone 2411, a cool-down zone 2412, and a post-cool-down zone 2413. The corresponding temperature limited frequency 2315 is represented by the solid line. As illustrated in FIG. 24, the performance capability of a core is updated as its temperature changes.

While this specific example uses 4 zones, the underlying principles of the invention are not limited to this particular set of zones. Different numbers of zones can be used under different implementations.

Pre-Hot Zone 2410: This is a zone where there is still sufficient thermal headroom before the core reaches its temperature limit 2402. Because of this, in this zone 2410, the core's temperature limited frequency 2315 is the core's maximum frequency (Fmax). The performance of the core within the pre-hot zone 2410 is determined based on this maximum frequency.

Hot Zone 2411: This is a zone where the cores temperature is increasing and there is only limited time before the core reaches its temperature limit 2402. Given that the OS could take time to observe the change, when the temperature of the core enters the hot zone 2411, the resolved temperature-constrained frequency, Fₛₐₜ, is used to determine the performance of the core (perf cap=perf@Fₛₐₜ). Note that the temperature threshold, denoted as HOT_TEMP_TH, can be different for different systems. For example, it may be set to 0 in some implementations in which the OS is capable of observing the change and responding in a sufficiently small amount of time.

Cool-down Zone 2412: This zone is entered when the core's temperature begins decreasing after peaking at its temperature limit 2402. In this zone, some implementations continue to use Fₛₐₜ to calculate the performance to avoid unnecessary oscillations.

Post-cool-down Zone: This zone is entered when a low temperature threshold is reached (COOL_DOWN_TEMP_TH). At this stage, there is a sufficient amount of thermal headroom available to increase the core's maximum frequency to Fmax when determining the core's performance (perf cap=perf@Fmax).

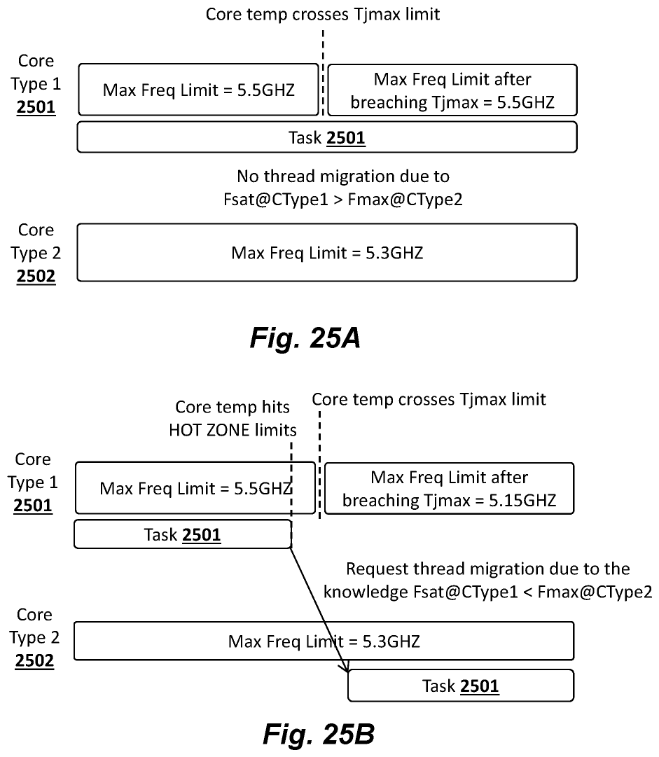

These embodiments can be used to achieve optimal task scheduling in different systems. For example, FIGS. 25A-B illustrate the operation of embodiments of the invention on processors with different power/thermal specifications. As shown in FIG. 25A, on a processor with a base power specification at or above a defined threshold (e.g., a 45 W SKU), a type 1 core 2501 will always achieve higher performance than a type 2 core 2502 (i.e., running at 5.5 GHz while the type 2 core runs at 5.3 GHz). Consequently, threads of task 2501 are not migrated to the type 2 core 2502, even when the type 1 core 2501 reaches its maximum frequency limit after breaching Tjmax.

In contrast, as shown in FIG. 25B, on a processor with a base power specification at or below another threshold (e.g., a 15 W SKU), the performance of the type 1 core 2501 will drop below that of the type 2 core after crossing Tjmax (e.g., 5.15 GHz compared to 5.3 GHz). As such, in this implementation, the threads of task 2501 are migrated to the type 2 core when the temperature of the type 1 core 2501 reaches the specified hot zone limit. The differences between FIGS. 25A and 25B result from understanding the differences in the behavior of the type 1 cores on the two different processors (e.g., the differences in the Fₛₐₜ values).

These embodiments of the invention have been shown to result in a 5% improvement on benchmarks hovering around thermal limits. In some embodiments, the temperature constrained frequency determination is performed by firmware and sent to the OS periodically (e.g., via updates to the capabilities table(s) 1440).

### Examples

Example 1. A processor, comprising: a plurality of cores; power management circuitry to associate a plurality of performance values and a plurality of efficiency values with the plurality of cores, wherein each core is to be associated with at least one performance value and at least one efficiency value, the plurality of performance values and the plurality of efficiency values to be used by a scheduler for scheduling threads on the plurality of cores; and dynamic core configuration hardware logic coupled to or integral to the power management circuitry to resolve a plurality of configuration hints into a consolidated hint for updating one or more performance values of the plurality of performance values and/or one or more efficiency values of the plurality of efficiency values.

Example 2. The processor of example 1, wherein the plurality of configuration hints comprise one or more different types of hints selected from the group comprising: core-specific parking hints, thread-specific parking hints, core consolidation hints, workload type (WLT) hints, SoC die biasing hints, and processor or system survivability hints.

Example 3. The processor of example 1 or 2, wherein the power management circuitry is to indicate or configure a priority mailbox to receive a thread-specific parking hint from a software or firmware component, the thread-specific parking hint to identify one or more cores or logical processors associated with the one or more cores to be reserved for executing a particular thread or group of threads.

Example 4. The processor of any of examples 1-3, wherein the plurality of cores include a plurality of relatively larger, relatively higher performance cores (P-cores) and a plurality of relatively smaller, relatively more efficient cores (E-cores).

Example 5. The processor of example 4, further comprising: a first die comprising: a memory controller to couple the processor to a system memory; a plurality of fabric interconnects to couple to other dies; and at least one E-core of the plurality of E-cores; a second die comprising: a shared cache; the plurality of P-cores coupled to the shared cache; multiple E-cores of the plurality of E-cores coupled to the shared cache; and a plurality of fabric interconnects to couple the second die to the first die.

Example 6. The processor of example 5, wherein the power management circuitry comprises a first power unit integral to the first die and a second power unit integral to the second die, wherein the second power unit is to send power management data related to the second die to the first power management unit, and wherein the first power management unit is to send requests to the second power management unit related to power and performance states of the plurality of P-cores and the multiple E-cores.

Example 7. The processor of any of examples 4-6 wherein the WLT hints include a first WLT hint indicating a high power or high performance workload, wherein responsive to the first WLT hint, the dynamic core configuration hardware logic is to generate the consolidated hint to configure the one or more performance values and the one or more efficiency values to restrict scheduling of the high power or high performance workload to one or more P-cores of the plurality of P-cores.

Example 8. The processor of example 7 wherein the WLT hints include a second WLT hint indicating an idle or low power workload, wherein responsive to the second WLT hint, the dynamic core configuration hardware logic is to generate the consolidated hint to configure the one or more performance values and the one or more efficiency values to restrict scheduling of the idle or low power workload to the at least one E-core of the plurality of E-cores of the first die.

Example 9. The processor of example 8, wherein responsive to the first WLT hint, the plurality of cores are to be sorted based on corresponding performance values to identify cores with the highest performance values for scheduling and wherein responsive to the second WLT hint, the plurality of cores are to be sorted based on corresponding efficiency values to identify cores of the plurality of cores with the highest efficiency values for scheduling.

Example 10. The processor of any of examples 2-9 wherein responsive to a processor or system survivability hint, the dynamic core configuration hardware logic is to generate the consolidated hint to configure the one or more performance values and the one or more efficiency values to cause a first subset of the plurality of cores to be parked to restrict scheduling to a second subset of the plurality of cores.

Example 11. The processor of any of examples 1-10 further comprising: utilization detection hardware logic to identify a subset of one or more cores of the plurality of cores with utilization levels below a first threshold or above a second threshold; and wherein the dynamic core configuration hardware logic is to generate the consolidated hint to configure the one or more performance values and the one or more efficiency values based on the identified subset of one or more cores.

Example 12. The processor of example 11 wherein the consolidated hint is to cause the subset of the one or more cores to be parked or consolidated or is to cause a different subset of cores to be parked or consolidated.

Example 13. The processor of example 12 wherein the dynamic core configuration hardware logic is to communicate one or more reasons for the parking or consolidation of the subset of the one or more cores or the different subset of cores.

Example 14. The processor of any of examples 1-13 further comprising: a first plurality of registers to store a plurality of performance/energy values, each register associated with a corresponding core of the plurality of cores to store a performance/energy value indicating a relative biasing between performance and energy for a current task executed on the corresponding core, wherein the dynamic core configuration hardware logic is to generate the consolidated hint to update one or more performance values and/or one or more efficiency values based, at least in part, on the performance/energy value stored in each register of the first plurality of registers.

Example 15. The processor of example 14 further comprising: a plurality of accelerator cores; a second plurality of registers, each register of the second plurality associated with a corresponding accelerator core to store a performance/energy value indicating a relative biasing between performance and energy for a workload executed on the corresponding accelerator core, wherein the dynamic core configuration hardware logic is to generate the consolidated hint to update one or more performance values and/or one or more efficiency values related to the plurality of accelerator cores based, at least in part, on the performance/energy value stored in each register of the second plurality of registers.

Example 16. The processor of example 15 wherein one or more of the plurality of accelerator cores comprise cores of a vector processing unit (VPU) and/or cores of an infrastructure processing unit (IPU).

Example 17. The processor of examples 15 or 16 wherein the power management circuitry is to indicate a maximum frequency for each core of the plurality of cores and each accelerator core of the plurality of accelerator cores in accordance with the one or more performance values and/or one or more efficiency values.

Example 18. The processor of example 17 wherein the power management circuitry comprises: a relative priority generator to generate a plurality of relative weight values based, at least in part, on the plurality of performance/energy values, each relative weight value associated with a corresponding core of the plurality of cores or a corresponding accelerator core of the plurality of accelerator cores.

Example 19. The processor of example 18 wherein the first power management circuitry further comprises: a global power balancer to determine the maximum frequency for each core of the plurality of cores and each accelerator core of the plurality of accelerator cores based, at least in part, on the plurality of relative weight values.

Example 20. A system comprising: a first die comprising: a plurality of cores including a plurality of relatively larger, relatively higher performance cores (P-cores) and a first plurality of relatively smaller, relatively more efficient cores (E-cores); first power management circuitry to associate a plurality of performance values and a plurality of efficiency values with the plurality of cores, the plurality of performance values and the plurality of efficiency values to be used by a scheduler for scheduling threads on the plurality of cores, wherein each core is to be associated with at least one performance value and at least one efficiency value; and dynamic core configuration hardware logic coupled to or integral to the power management circuitry to resolve a plurality of configuration hints into a consolidated hint for updating one or more performance values of the plurality of performance values and/or one or more efficiency values of the plurality of efficiency values; and a second die comprising: a second plurality of E-cores; a memory controller to couple the plurality of cores to a system memory; and a fabric interconnect to couple to the first die; second power management circuitry to implement power management operations communicated by the first power management circuitry.

Example 21. The system of example 20, wherein the plurality of configuration hints comprise one or more different types of hints selected from the group comprising: core-specific parking hints, thread-specific parking hints, core consolidation hints, workload type (WLT) hints, SoC die biasing hints, and processor or system survivability hints.

Example 22. The system of examples 20 or 21, wherein the power management circuitry is to indicate or configure a priority mailbox to receive a thread-specific parking hint from a software or firmware component, the thread-specific parking hint to identify one or more cores or logical processors associated with the one or more cores to be reserved for executing a particular thread or group of threads.

Example 23. The system of any of examples 20-22, wherein the power management circuitry comprises a first power unit integral to the first die and a second power unit integral to the second die, wherein the second power unit is to send power management data related to the second die to the first power management unit, and wherein the first power management unit is to send requests to the second power management unit related to power and performance states of the plurality of P-cores and the multiple E-cores.

Example 24. The system of examples 22 or 23 wherein the WLT hints include a first WLT hint indicating a high power or high performance workload, wherein responsive to the first WLT hint, the dynamic core configuration hardware logic is to generate the consolidated hint to configure the one or more performance values and the one or more efficiency values to restrict scheduling of the high power or high performance workload to one or more P-cores of the plurality of P-cores.

Example 25. The system of example 24 wherein the WLT hints include a second WLT hint indicating an idle or low power workload, wherein responsive to the second WLT hint, the dynamic core configuration hardware logic is to generate the consolidated hint to configure the one or more performance values and the one or more efficiency values to restrict scheduling of the idle or low power workload to the at least one E-core of the plurality of E-cores of the first die.

Example 26. The system of example 25, wherein responsive to the first WLT hint, the plurality of cores are to be sorted based on corresponding performance values to identify cores with the highest performance values for scheduling and wherein responsive to the second WLT hint, the plurality of cores are to be sorted based on corresponding efficiency values to identify cores of the plurality of cores with the highest efficiency values for scheduling.

Example 27. The system of any of examples 21-26 wherein responsive to a processor or system survivability hint, the dynamic core configuration hardware logic is to generate the consolidated hint to configure the one or more performance values and the one or more efficiency values to cause a first subset of the plurality of cores to be parked to restrict scheduling to a second subset of the plurality of cores.

Example 28. The system of any of examples 20-27 further comprising: utilization detection hardware logic to identify a subset of one or more cores of the plurality of cores with utilization levels below a first threshold or above a second threshold; and wherein the dynamic core configuration hardware logic is to generate the consolidated hint to configure the one or more performance values and the one or more efficiency values based on the identified subset of one or more cores.

Example 29. The system of example 28 wherein the consolidated hint is to cause the subset of the one or more cores to be parked or consolidated or is to cause a different subset of cores to be parked or consolidated.

Example 30. The system of example 29 wherein the dynamic core configuration hardware logic is to communicate one or more reasons for the parking or consolidation of the subset of the one or more cores or the different subset of cores.

Example 31. The system of any of examples 20-30 further comprising: a first plurality of registers to store a plurality of performance/energy values, each register associated with a corresponding core of the plurality of cores to store a performance/energy value indicating a relative biasing between performance and energy for a current task executed on the corresponding core, wherein the dynamic core configuration hardware logic is to generate the consolidated hint to update one or more performance values and/or one or more efficiency values based, at least in part, on the performance/energy value stored in each register of the first plurality of registers.

Example 32. The system of example 31 further comprising: a plurality of accelerator cores; a second plurality of registers, each register of the second plurality associated with a corresponding accelerator core to store a performance/energy value indicating a relative biasing between performance and energy for a workload executed on the corresponding accelerator core, wherein the dynamic core configuration hardware logic is to generate the consolidated hint to update one or more performance values and/or one or more efficiency values related to the plurality of accelerator cores based, at least in part, on the performance/energy value stored in each register of the second plurality of registers.

Example 33. The system of example 32 wherein one or more of the plurality of accelerator cores comprise cores of a vector processing unit (VPU) and/or cores of an infrastructure processing unit (IPU).

Example 34. The system of examples 32 or 33 wherein the first power management circuitry is to indicate a maximum frequency for each core of the plurality of cores and each accelerator core of the plurality of accelerator cores in accordance with the one or more performance values and/or one or more efficiency values.

Example 35. The system of example 34 wherein the first power management circuitry comprises: a relative priority generator to generate a plurality of relative weight values based, at least in part, on the plurality of performance/energy values, each relative weight value associated with a corresponding core of the plurality of cores or a corresponding accelerator core of the plurality of accelerator cores.

Example 36. The system of example 35 wherein the first power management circuitry further comprises: a global power balancer to determine the maximum frequency for each core of the plurality of cores and each accelerator core of the plurality of accelerator cores based, at least in part, on the plurality of relative weight values.

Example 37. A method comprising: associate a plurality of performance values and a plurality of efficiency values with a plurality of cores, wherein at least one performance value and at least one efficiency value is associated with each core of a plurality of cores; scheduling threads on the plurality of cores based on the plurality of performance values and plurality of efficiency values; and resolving a plurality of configuration hints into a consolidated hint for updating one or more performance values of the plurality of performance values and/or one or more efficiency values of the plurality of efficiency values.

Example 38. The method of example 37, wherein the plurality of configuration hints comprise one or more different types of hints selected from the group comprising: core-specific parking hints, thread-specific parking hints, core consolidation hints, workload type (WLT) hints, SoC die biasing hints, and processor or system survivability hints.

Example 39. The method of example 37 or 38, further comprising: indicating or configuring a priority mailbox to receive a thread-specific parking hint from a software or firmware component, the thread-specific parking hint to identify one or more cores or logical processors associated with the one or more cores to be reserved for executing a particular thread or group of threads.

Example 40. The method of any of examples 37-39, wherein the plurality of cores include a plurality of relatively larger, relatively higher performance cores (P-cores) and a plurality of relatively smaller, relatively more efficient cores (E-cores).

Example 41. The method of example 40 wherein the WLT hints include a first WLT hint indicating a high power or high performance workload, the method further comprising: generating the consolidated hint responsive to the first WLT hint to configure the one or more performance values and the one or more efficiency values to restrict scheduling of the high power or high performance workload to one or more P-cores of the plurality of P-cores.

Example 42. The method of example 41 wherein the WLT hints include a second WLT hint indicating an idle or low power workload, the method further comprising: generating the consolidated hint responsive to the second WLT hint to configure the one or more performance values and the one or more efficiency values to restrict scheduling of the idle or low power workload to the at least one E-core of the plurality of E-cores of the first die.

Example 43. The method of example 42, further comprising: sorting the plurality of cores responsive to the first WLT hint, and based on corresponding performance values to identify cores with the highest performance values for scheduling; or sorting the plurality of cores responsive to the second WLT hint, and based on corresponding efficiency values to identify cores of the plurality of cores with the highest efficiency values for scheduling.

Example 44. The method of any of examples 38-43 further comprising: generating the consolidated hint responsive to a processor or system survivability hint to configure the one or more performance values and the one or more efficiency values to cause a first subset of the plurality of cores to be parked to restrict scheduling to a second subset of the plurality of cores.

Example 45. The method of any of examples 38-44 further comprising: identifying a subset of one or more cores of the plurality of cores with utilization levels below a first threshold or above a second threshold; and wherein the dynamic core configuration hardware logic is to generate the consolidated hint to configure the one or more performance values and the one or more efficiency values based on the identified subset of one or more cores.

Example 46. The method of example 45 wherein the consolidated hint is to cause the subset of the one or more cores to be parked or consolidated or is to cause a different subset of cores to be parked or consolidated.

Example 47. The method of example 46 further comprising: communicating one or more reasons for the parking or consolidation of the subset of the one or more cores or the different subset of cores.

Example 48. The method of any of examples 37-47 further comprising: storing a plurality of performance/energy values in a plurality of registers, each performance/energy value indicating a relative biasing between performance and energy for a current task executed on a corresponding core, wherein generating the consolidated hint comprises updating one or more performance values and/or one or more efficiency values based, at least in part, on the performance/energy value stored in each register of the first plurality of registers.

Example 49. The method of example 48 further comprising: generating a plurality of relative weight values based, at least in part, on the plurality of performance/energy values, each relative weight value associated with a corresponding core of the plurality of cores.

Example 50. The method of example 49 further comprising: determining the maximum frequency for each core of the plurality of cores based, at least in part, on the plurality of relative weight values.

Example 51. A machine-readable medium having program code stored thereon which, when executed by a machine, causes the machine to perform the operations of: associate a plurality of performance values and a plurality of efficiency values with a plurality of cores, wherein at least one performance value and at least one efficiency value is associated with each core of a plurality of cores; scheduling threads on the plurality of cores based on the plurality of performance values and plurality of efficiency values; and resolving a plurality of configuration hints into a consolidated hint for updating one or more performance values of the plurality of performance values and/or one or more efficiency values of the plurality of efficiency values.

Example 52. The machine-readable medium of example 51, wherein the plurality of configuration hints comprise one or more different types of hints selected from the group comprising: core-specific parking hints, thread-specific parking hints, core consolidation hints, workload type (WLT) hints, SoC die biasing hints, and processor or system survivability hints.

Example 53. The machine-readable medium of example 51 or 52, further comprising program code to cause the machine to perform the operations of: indicating or configuring a priority mailbox to receive a thread-specific parking hint from a software or firmware component, the thread-specific parking hint to identify one or more cores or logical processors associated with the one or more cores to be reserved for executing a particular thread or group of threads.

Example 54. The machine-readable medium of any of examples 51-53, wherein the plurality of cores include a plurality of relatively larger, relatively higher performance cores (P-cores) and a plurality of relatively smaller, relatively more efficient cores (E-cores).

Example 55. The machine-readable medium of example 54 wherein the WLT hints include a first WLT hint indicating a high power or high performance workload, the machine-readable medium further comprising program code to cause the machine to perform the operations of: generating the consolidated hint responsive to the first WLT hint to configure the one or more performance values and the one or more efficiency values to restrict scheduling of the high power or high performance workload to one or more P-cores of the plurality of P-cores.

Example 56. The machine-readable medium of example 55 wherein the WLT hints include a second WLT hint indicating an idle or low power workload, the machine-readable medium further comprising program code to cause the machine to perform the operations of: generating the consolidated hint responsive to the second WLT hint to configure the one or more performance values and the one or more efficiency values to restrict scheduling of the idle or low power workload to the at least one E-core of the plurality of E-cores of the first die.

Example 57. The machine-readable medium of example 56, further comprising program code to cause the machine to perform the operations of: sorting the plurality of cores responsive to the first WLT hint, and based on corresponding performance values to identify cores with the highest performance values for scheduling; or sorting the plurality of cores responsive to the second WLT hint, and based on corresponding efficiency values to identify cores of the plurality of cores with the highest efficiency values for scheduling.

Example 58. The machine-readable medium of any of examples 52-57 further comprising program code to cause the machine to perform the operations of: generating the consolidated hint responsive to a processor or system survivability hint to configure the one or more performance values and the one or more efficiency values to cause a first subset of the plurality of cores to be parked to restrict scheduling to a second subset of the plurality of cores.

Example 59. The machine-readable medium of any of examples 52-58 further comprising program code to cause the machine to perform the operations of: identifying a subset of one or more cores of the plurality of cores with utilization levels below a first threshold or above a second threshold; and wherein the dynamic core configuration hardware logic is to generate the consolidated hint to configure the one or more performance values and the one or more efficiency values based on the identified subset of one or more cores.

Example 60. The machine-readable medium of example 59 wherein the consolidated hint is to cause the subset of the one or more cores to be parked or consolidated or is to cause a different subset of cores to be parked or consolidated.

Example 61. The machine-readable medium of example 60 further comprising program code to cause the machine to perform the operations of: communicating one or more reasons for the parking or consolidation of the subset of the one or more cores or the different subset of cores.

Example 62. The machine-readable medium of any of examples 51-61 further comprising program code to cause the machine to perform the operations of: storing a plurality of performance/energy values in a plurality of registers, each performance/energy value indicating a relative biasing between performance and energy for a current task executed on a corresponding core, wherein generating the consolidated hint comprises updating one or more performance values and/or one or more efficiency values based, at least in part, on the performance/energy value stored in each register of the first plurality of registers.

Example 63. The machine-readable medium of example 62 further comprising program code to cause the machine to perform the operations of: generating a plurality of relative weight values based, at least in part, on the plurality of performance/energy values, each relative weight value associated with a corresponding core of the plurality of cores.

Example 64. The machine-readable medium of example 63 further comprising program code to cause the machine to perform the operations of: determining the maximum frequency for each core of the plurality of cores based, at least in part, on the plurality of relative weight values.

In the foregoing specification, the embodiments of invention have been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A processor, comprising:
a plurality of cores;
power management circuitry to associate a plurality of performance values and a plurality of efficiency values with the plurality of cores, wherein each core is to be associated with at least one performance value and at least one efficiency value, the plurality of performance values and the plurality of efficiency values to be used by a scheduler for scheduling threads on the plurality of cores; and
core configuration circuitry coupled to or integral to the power management circuitry to resolve a plurality of configuration hints into a consolidated hint for updating one or more performance values of the plurality of performance values and/or one or more efficiency values of the plurality of efficiency values.

2. The processor of claim 1, wherein the plurality of configuration hints comprise one or more different types of hints selected from the group comprising: core-specific parking hints, thread-specific parking hints, core consolidation hints, workload type (WLT) hints, SoC die biasing hints, and processor or system survivability hints.

3. The processor of claim 1, wherein the power management circuitry is to indicate or configure a priority mailbox to receive a thread-specific parking hint from a software or firmware component, the thread-specific parking hint to identify one or more cores or logical processors associated with the one or more cores to be reserved for executing a particular thread or group of threads.

4. The processor of claim 1, wherein the plurality of cores include a plurality of relatively larger, relatively higher performance cores (P-cores) and a plurality of relatively smaller, relatively more efficient cores (E-cores).

5. The processor of claim 4, further comprising:
a first die comprising:
a memory controller to couple the processor to a system memory;
a plurality of fabric interconnects to couple to other dies; and
at least one E-core of the plurality of E-cores;
a second die comprising:
a shared cache;
the plurality of P-cores coupled to the shared cache;
multiple E-cores of the plurality of E-cores coupled to the shared cache; and
a plurality of fabric interconnects to couple the second die to the first die.

6. The processor of claim 5, wherein the power management circuitry comprises a first power unit integral to the first die and a second power unit integral to the second die, wherein the second power unit is to send power management data related to the second die to the first power management unit, and wherein the first power management unit is to send requests to the second power management unit related to power and performance states of the plurality of P-cores and the multiple E-cores.

7. The processor of claim 6 wherein the WLT hints include a first WLT hint indicating a high power or high performance workload, wherein responsive to the first WLT hint, the dynamic core configuration hardware logic is to generate the consolidated hint to configure the one or more performance values and the one or more efficiency values to restrict scheduling of the high power or high performance workload to one or more P-cores of the plurality of P-cores.

8. A method comprising:
associating a plurality of performance values and a plurality of efficiency values with a plurality of cores, wherein at least one performance value and at least one efficiency value is associated with each core of a plurality of cores;
scheduling threads on the plurality of cores based on the plurality of performance values and plurality of efficiency values; and
resolving a plurality of configuration hints into a consolidated hint for updating one or more performance values of the plurality of performance values and/or one or more efficiency values of the plurality of efficiency values.

9. The method of claim 8, wherein the plurality of configuration hints comprise one or more different types of hints selected from the group comprising: core-specific parking hints, thread-specific parking hints, core consolidation hints, workload type (WLT) hints, SoC die biasing hints, and processor or system survivability hints.

10. The method of claim 8, further comprising:
indicating or configuring a priority mailbox to receive a thread-specific parking hint from a software or firmware component, the thread-specific parking hint to identify one or more cores or logical processors associated with the one or more cores to be reserved for executing a particular thread or group of threads.

11. The method of claim 8, wherein the plurality of cores include a plurality of relatively larger, relatively higher performance cores (P-cores) and a plurality of relatively smaller, relatively more efficient cores (E-cores).

12. The method of claim 11 wherein the WLT hints include a first WLT hint indicating a high power or high performance workload, the method further comprising:
generating the consolidated hint responsive to the first WLT hint to configure the one or more performance values and the one or more efficiency values to restrict scheduling of the high power or high performance workload to one or more P-cores of the plurality of P-cores.

13. The method of claim 12 wherein the WLT hints include a second WLT hint indicating an idle or low power workload, the method further comprising:
generating the consolidated hint responsive to the second WLT hint to configure the one or more performance values and the one or more efficiency values to restrict scheduling of the idle or low power workload to the at least one E-core of the plurality of E-cores of the first die.

14. The method of claim 13, further comprising:
sorting the plurality of cores responsive to the first WLT hint, and based on corresponding performance values to identify cores with the highest performance values for scheduling; or
sorting the plurality of cores responsive to the second WLT hint, and based on corresponding efficiency values to identify cores of the plurality of cores with the highest efficiency values for scheduling.

15. A machine-readable medium having program code stored thereon which, when executed by a machine, causes the machine to perform the operations of:
associating a plurality of performance values and a plurality of efficiency values with a plurality of cores, wherein at least one performance value and at least one efficiency value is associated with each core of a plurality of cores;
scheduling threads on the plurality of cores based on the plurality of performance values and plurality of efficiency values; and
resolving a plurality of configuration hints into a consolidated hint for updating one or more performance values of the plurality of performance values and/or one or more efficiency values of the plurality of efficiency values.

16. The machine-readable medium of claim 15, wherein the plurality of configuration hints comprise one or more different types of hints selected from the group comprising: core-specific parking hints, thread-specific parking hints, core consolidation hints, workload type (WLT) hints, SoC die biasing hints, and processor or system survivability hints.

17. The machine-readable medium of claim 15, further comprising program code to cause the machine to perform the operations of:
indicating or configuring a priority mailbox to receive a thread-specific parking hint from a software or firmware component, the thread-specific parking hint to identify one or more cores or logical processors associated with the one or more cores to be reserved for executing a particular thread or group of threads.

18. The machine-readable medium of claim 15, wherein the plurality of cores include a plurality of relatively larger, relatively higher performance cores (P-cores) and a plurality of relatively smaller, relatively more efficient cores (E-cores).

19. The machine-readable medium of claim 18 wherein the WLT hints include a first WLT hint indicating a high power or high performance workload, the machine-readable medium further comprising program code to cause the machine to perform the operations of:
generating the consolidated hint responsive to the first WLT hint to configure the one or more performance values and the one or more efficiency values to restrict scheduling of the high power or high performance workload to one or more P-cores of the plurality of P-cores.

20. The machine-readable medium of claim 19 wherein the WLT hints include a second WLT hint indicating an idle or low power workload, the machine-readable medium further comprising program code to cause the machine to perform the operations of:
generating the consolidated hint responsive to the second WLT hint to configure the one or more performance values and the one or more efficiency values to restrict scheduling of the idle or low power workload to the at least one E-core of the plurality of E-cores of the first die.
